(19) United States
(12) Patent Application Publication
(10) Pub. No.: US 2011/0134400 A1
(43) Pub. Date: Jun. 9, 2011

(54) EXPOSURE APPARATUS, LIQUID IMMERSION MEMBER, AND DEVICE MANUFACTURING METHOD

(75) Inventor: Yuichi SHIBAZAKI, Kumagaya-shi (JP)

(73) Assignee: NIKON CORPORATION, Tokyo (JP)

(21) Appl. No.: 12/956,399

(22) Filed: Nov. 30, 2010

Related U.S. Application Data
(60) Provisional application No. 61/390,716, filed on Oct. 7, 2010.
(60) Provisional application No. 61/308,592, filed on Feb. 26, 2010.
(60) Provisional application No. 61/308,574, filed on Feb. 26, 2010.
(60) Provisional application No. 61/308,570, filed on Feb. 26, 2010.
(60) Provisional application No. 61/282,029, filed on Dec. 4, 2009.

(30) Foreign Application Priority Data
Feb. 19, 2010 (JP) 2010-034321
Feb. 19, 2010 (JP) 2010-034327
Feb. 19, 2010 (JP) 2010-034346
Sep. 17, 2010 (JP) 2010-209036

(51) Int. Cl. G03B 27/52

(52) U.S. Cl. 355/30

(57) ABSTRACT

Liquid is held between a tip lens of a projection optical system and a wafer on a wafer stage, using a nozzle member which has shape enclosing an optical path of an illumination light, and a bottom surface to which wafer W is placed facing via a predetermined clearance that has an annular recess section formed having multiple projecting sections. This prevents adhesion of contamination and liquid from remaining that become factors of defects of a pattern formed on a wafer. The nozzle member preferably has an annular shaped inclined surface whose gap with the wafer surface becomes smaller from the inner side to the outer side, formed on an inner bottom surface facing the wafer of an outer recess section formed on the bottom surface of the nozzle member.

### CROSS-REFERENCE TO RELATED APPLICATIONS

This non-provisional application claims the benefit of Provisional Application No. 61/282,029 filed Dec. 4, 2009, Provisional Application Nos. 61/308,570, 61/308,574, and 61/308,592 filed Feb. 26, 2010, and Provisional Application No. 61/390,716 filed Oct. 7, 2010, the disclosures of which are hereby incorporated herein by reference in their entirety.

### BACKGROUND OF THE INVENTION

1. Field of the Invention

The present invention relates to exposure apparatuses, liquid immersion members, and device manufacturing methods, and more particularly, to an exposure apparatus used in a photolithography process when producing electronic devices such as a semiconductor device, a liquid crystal display device and the like that performs exposure by a liquid immersion method, a liquid immersion member which can be used to form a liquid immersion space that is filled with liquid, and a device manufacturing method which uses the exposure apparatus.

2. Description of the Background Art

In a photolithography process for manufacturing electron devices (microdevices) such as semiconductor devices, liquid crystal display devices and the like, exposure apparatuses such as a projection exposure apparatus by a step-and-repeat method (a so-called stepper) and a projection exposure apparatus by a step-and-scan method (a so-called scanning stepper (which is also called a scanner) are used. In these types of exposure apparatuses, in order to meet the requirement's for higher resolution (resolving power) year by year that accompany finer patterns due to higher integration of semiconductor devices (integrated circuits) and the like, attempts have been made to shorten the wavelength of the exposure light and to increase the numerical aperture (a higher NA) of the projection optical system. Further, in recent years, exposure apparatuses are being developed that use a liquid immersion method as a method of substantially shortening the exposure wavelength and also widening the depth of focus when compared with the depth of focus in the air. This immersion method is a method in which water or liquid (refractive index n>1) such as an organic solvent and the like is supplied to a local space between a lower surface of a projection optical system and a wafer surface so as to form a liquid immersion space, and exposure is performed via the liquid of the liquid immersion space.

Further, conventionally, in order to maintain the liquid immersion space in a local area, a liquid repellent coating was applied to the wafer surface to keep the liquid from spreading (for example, refer to U.S. Patent Application Publication No. 2008/0266533) on a surface besides the lower surface of the projection optical system, or an air curtain was formed (for example, refer to U.S. Pat. No. 7,193,681) by blowing gas against the periphery of the liquid immersion area.

However, in the exposure apparatus disclosed in U.S. Patent Application Publication No. 2008/0266533, liquid is collected via a member (a porous member) having a plurality of holes which are made to cover a liquid recovery port, such as for example, a mesh member having a plurality of holes. Therefore, contaminants adhered to the porous member, which became a cause of defects in the pattern formed on the wafer (hereinafter shortly referred to as a defect). Accordingly, the contaminated porous member has to be replaced; however, this replacement becomes a cause of increasing the downtime of the apparatus, which leads to a decrease in throughput, which then leads to an increase in cost. Further, in the liquid immersion exposure apparatus by a step-and-scan method as disclosed in U.S. Patent Application Publication No. 2008/0266533, the liquid may remain on the wafer with the movement of the wafer. The liquid which has remained on the wafer becomes a cause of defects. Further, the heat of evaporation which is generated when the remaining liquid evaporates becomes a cause of local deformation of the wafer.

Further, when the liquid immersion space was limited by an air curtain like the one disclosed in U.S. Pat. No. 7,193,681 and the like, a problem such as deformation of the wafer due to the heat of evaporation could occur.

Further, in ArF liquid immersion lithography, for example, in the case of using water (refractive index is 1.44 at 193[nm]>, pattern formation is possible even when using a projection lens whose NA is 1.0 or more, and the NA can be increased up to 1.35. The resolving power also improves with the increase of the NA, and a possibility of a 45 nm node is shown by a combination of a projection lens whose NA is 1.2 or more and a strong super-resolution technology (for example, refer to, proceedings of SPIE Vol. 5040, p. 724).

However, requirements for improving the resolution to the exposure apparatus show no sign of slowing down, and as a leading candidate to further improve the resolution, a liquid immersion lithography using a high refractive index liquid whose refractive index is higher than water can be given.

However, the high refractive index liquid generally has a characteristic of having a small contact angle (a large wettability) which makes it difficult to maintain its shape. Accordingly, it was difficult to keep a high refractive index liquid in a local area between the projection optical system and the substrate, and a local-fill liquid immersion exposure using the high refractive index liquid could not be performed in the past.

### SUMMARY OF THE INVENTION

According to a first aspect of the present invention, there is provided an exposure apparatus that exposes an object with an energy beam via an optical member and a liquid, the apparatus comprising: a liquid immersion member which is placed facing the object on an outer periphery side of abeam path of the energy beam, and on a first surface to which the object is placed opposing, a first recess section to form an auxiliary liquid immersion space between the object and the liquid immersion member is formed; and a first liquid supply system which supplies the liquid inside the liquid immersion member to form a liquid immersion space between the optical member and the object.

According to this apparatus, on the outer side of a liquid immersion space formed in between an optical member and the object, an auxiliary liquid immersion space is formed by a liquid immersion member between the liquid immersion member and the object. Therefore, an air curtain and the like does not have to be used, and a mesh member having a plurality of holes will not have to be used to recover the liquid inside of the liquid immersion space. Further, exposure with high-resolution to the object becomes possible by the liquid immersion exposure.

According to a second aspect of the present invention, there is provided an exposure apparatus that exposes an object with an energy beam via an optical member and a liquid, the apparatus comprising: a liquid immersion member which is placed facing the object to form a liquid immersion space of the liquid including a beam path of the energy beam between the optical member and the object, and has a first recess section to form an auxiliary liquid immersion space in between with the object formed on a first surface to which the object is placed opposing; and a first liquid supply system which supplies the liquid to the liquid immersion space.

According to this apparatus, on the outer side of a liquid immersion space formed in between an optical member and the object, an auxiliary liquid immersion space is formed by a liquid immersion member between the liquid immersion member and the object. Therefore, an air curtain and the like does not have to be used, and a mesh member having a plurality of holes will not have to be used to recover the liquid inside of the liquid immersion space. Further, exposure with high-resolution to the object becomes possible by the liquid immersion exposure.

According to a third aspect of the present invention, there is provided a device manufacturing method, including exposing an object using one of the first and second exposure apparatuses of the present invention; and developing the object which has been exposed.

According to a fourth aspect of the present invention, there is provided a liquid immersion member which fills liquid in a space between an optical member and an object and forms a liquid immersion space, and is attached to an exposure apparatus which exposes the object with an energy beam via the optical member and the liquid, the member comprising: a main section which can be placed facing the object on an outer side of a beam path of the energy beam, and also has a space formed in the center to form the liquid immersion space, wherein a first recess section to form an auxiliary liquid immersion space between the object is formed on a first surface of the main section facing the object.

According to this member, an air curtain and the like does not have to be used, and a mesh member having a plurality of holes will not have to be used to recover the liquid inside of the liquid immersion space.

### BRIEF DESCRIPTION OF THE DRAWINGS

In the accompanying drawings;

FIG. 1 is a view that schematically shows a configuration of an exposure apparatus of a first embodiment;

FIG. 2 is a perspective view that shows a Z tilt stage;

FIG. 3 is a longitudinal sectional view that shows the +Y side half of nozzle member 32, with the −Y side half omitted;

FIG. 4 is a view used to explain a configuration related to a purge of wet air;

FIG. 5 is a view used to explain an example of a combination of components which configure a nozzle member;

FIG. 6 is a view used to explain a principle of liquid enclosure (No. 1);

FIG. 7 is a velocity distribution of liquid Lq in a height direction (the Z-axis direction) in the case wafer W moves in the +Y direction at a velocity V₀;

FIG. 8 is a graph that shows an example of a result when obtaining critical velocity V_{crit} (mm/a) in the range of gap h=0.1-0.7 (mm);

FIGS. 9A and 9B are views to explain a principle of liquid enclosure (No. 2);

FIG. 10 is a view used to explain a liquid flow in the vicinity of a nozzle member;

FIG. 11 is a block diagram that shows input/output relations of a main controller which the exposure apparatus of FIG. 1 is equipped with;

FIGS. 12A and 12B are views used to explain an operation effect by having set up a buffer space;

FIG. 13 is a view used to explain a cleaning of the nozzle member;

FIG. 14 is a perspective view that shows a vicinity of an inclined surface of the nozzle member which the exposure apparatus of the second embodiment is equipped with;

FIGS. 15A to 15C are views used to explain a flow of liquid in the vicinity of grooves of the inclined surface;

FIG. 16 is a view used to explain a conversion of a flow of liquid. Lq within the second liquid immersion space 14₂ to an equivalent parallel plate flow;

FIG. 17 is a velocity distribution (in a parallel plate flow after the conversion) of liquid Lq in a height direction (the Z-axis direction) in the ease wafer W moves in the +Y direction at a velocity V₀;

FIG. 18 is a graph that shows an example of a result when obtaining critical velocity V_{crit} (mm/s) in the range of gap h=0.1-0.7 (mm) in the second embodiment;

FIG. 19 is a longitudinal sectional view that shows the +Y side half of a nozzle member related to a third embodiment, with the −Y side half omitted;

FIG. 20 is a block diagram that shows an input/output relation of a main controller which is equipped in the exposure apparatus of the third embodiment; and

FIG. 21 is a longitudinal sectional view that shows the +Y side half of a nozzle member related to a modified example of the third embodiment, with the −Y side half omitted.

### DESCRIPTION OF THE EMBODIMENTS

### First Embodiment

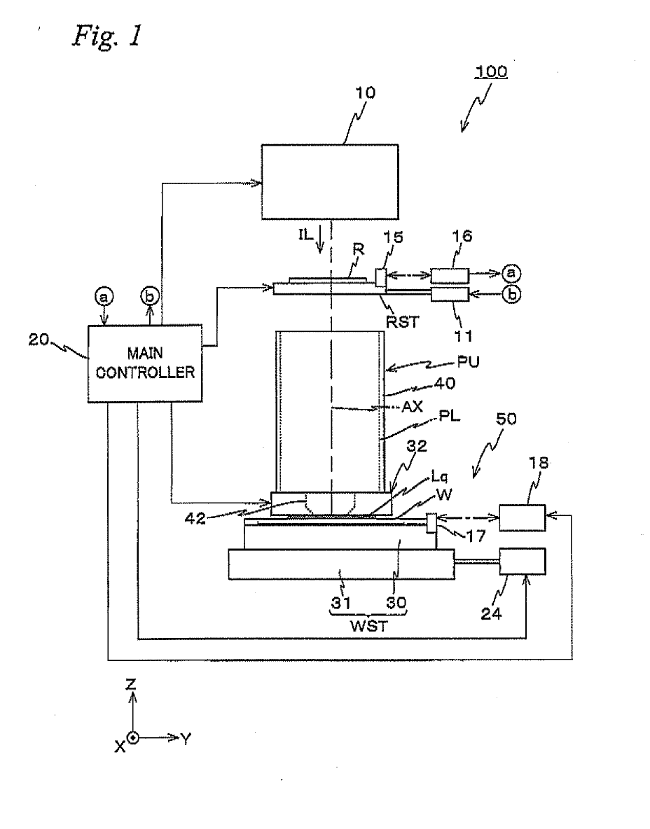

Hereinafter, a first embodiment of the present invention will be described, with reference to FIGS. 1 to 13.

FIG. 1 schematically shows the configuration of an exposure apparatus 100 related to the present embodiment. Exposure apparatus 100 is a projection exposure apparatus by the step-and-scan method (or a so-called scanning stepper). As it will be described later, a projection optical system PL is arranged in the embodiment, and in the description below, a direction parallel to an optical axis AX of projection optical system PL will be described as the Z-axis direction, a direction within a plane orthogonal to the Z-axis direction in which a reticle and a wafer are relatively scanned will be described as the Y-axis direction, a direction orthogonal to the Z-axis and the Y-axis will be described as the X-axis direction, and rotational (inclination) directions around the X-axis, the Y-axis, and the Z-axis will be described as θx, θt, and θz directions, respectively.

Exposure apparatus 100 is equipped with an illumination system 10, a reticle stage RST holding reticle R, a projection unit PU, a stage device 50 including wafer stage WST on which a wafer W is loaded, a control system for these parts and the like.

Illumination system 10 includes: a light source; and an illumination optical system that has an illuminance uniformity optical system including an optical integrator and the like, and a reticle blind and the like (none of which are illustrated), as disclosed in, for example, U.S. Patent Application Publication No. 2003/0025890 and the like. Illumination system 10 illuminates a slit-shaped illumination area IAR, which is defined by the reticle blind (which is also referred to as a masking system), on reticle R with illumination light (exposure light) IL with substantially uniform illuminance. In this case, as illumination light IL, for example, an ArF excimer laser beam (wavelength 193 [nm]) is used.

On reticle stage RST, reticle R having a pattern surface (the lower surface in FIG. 1) on which a circuit pattern and the like are formed is fixed by, for example, vacuum adsorption. Reticle stage RST is finely drivable within an XY plane, for example, by a reticle stage drive system 11 that includes a linear motor or the like, and reticle stage RST is also drivable in a scanning direction (in this case, the Y-axis direction, which is the lateral direction of the page surface in FIG. 1) at a predetermined scanning speed.

The positional information (including rotation information in the θz direction) of reticle stage RST in the XY plane is constantly detected, for example, at a resolution of around 0.25 [nm] by a reticle laser interferometer (hereinafter referred to as a “reticle interferometer”) 16, via a′ movable mirror 15 fixed on reticle stage RST. Measurement values of reticle interferometer 10 are sent to main controller 20. Incidentally, the positional information of reticle stage RST can be measured by an encoder system as is disclosed in, for example, U.S. Patent Application Publication 2007/0288121 and the like.

Main controller 20 drives (controls) reticle stage RST via reticle stage drive system 11, based on the positional information of reticle stage RST.

Projection unit PU is placed below reticle stage RST (on the −Z side) in FIG. 1. Projection unit PU is supported by a main frame (not shown) (also called a metrology frame) BU supported horizontally by a support member (not shown), via a flange portion provided in the outer periphery of the projection unit. Projection unit PU includes a barrel 40 and projection optical system PL held within barrel 40. As projection optical system PL, for example, a dioptric system is used, which is composed of a plurality of lenses (lens elements) that are arrayed along an optical axis AX direction parallel to the Z-axis direction, and is both-side telecentric, and has a predetermined projection magnification (such as one-quarter, one-fifth or one-eighth times). Therefore, when illumination system 10 illuminates an illumination area on reticle R with illumination area IL, by illumination light IL which has passed through reticle R placed so that its pattern surface substantially coincides with a first surface (object surface) of projection optical system PL, a reduced image of the circuit pattern of reticle R within an illumination area IAR via projection optical system PL (projection unit PU) is formed on an area (hereinafter also referred to as an exposure area) conjugate with illumination area IAR on a wafer W whose surface is coated with a resist (a sensitive agent) and is placed on a second surface (image plane surface) side of projection optical system PL. And by a synchronous drive of reticle stage RST holding reticle R and wafer stage WST holding wafer W, reticle R is relatively moved in the scanning direction (the Y-axis direction) with respect to illumination area IAR (illumination light IL) while wafer W is relatively moved in the scanning direction (the Y-axis direction) with respect to exposure area IA (illumination light IL), thus scanning exposure of a shot area (divided area) on wafer W is performed, and the pattern of reticle R is transferred onto the shot area. That is, in the embodiment, the pattern of reticle R is generated on wafer W according to illumination system 10 and projection optical system FL, and then by the exposure of the sensitive layer (resist layer) on wafer W with illumination light IL, the pattern is formed on wafer W. In the embodiment, the main frame supporting projection unit PU is supported almost horizontally by a plurality of (e.g. three or four) support members which are each placed on an installation surface (such as the floor surface) via a vibration isolation mechanism. Incidentally, the vibration isolating mechanism can be placed between each of the support members and the main frame. Further, as is disclosed in, for example, U.S. Patent Application Publication No. 2008/068568, projection unit PU can be supported by suspension with respect to a main frame member or to a reticle base (not shown), placed above projection unit PU.

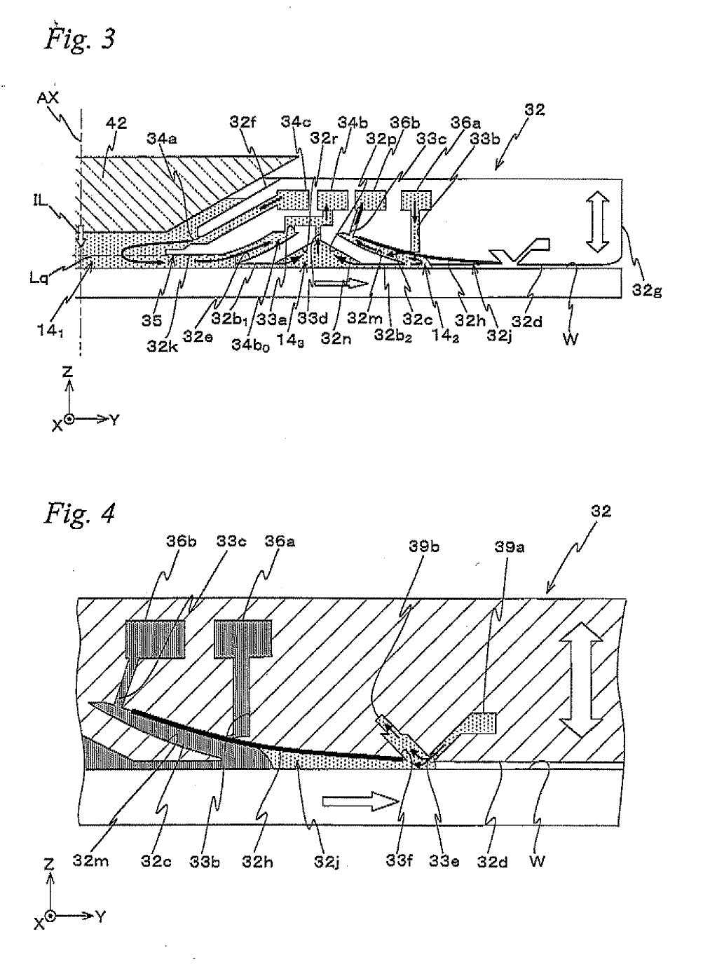

Further, in exposure apparatus 100 of the embodiment, because exposure (liquid immersion exposure) to which a liquid immersion method is applied is performed as it will be described later on, a nozzle member 32 is installed (refer to FIG. 3) in the vicinity of a lens (tip lens) 42 serving as an optical element which is closest to the image plane (the wafer W side) that configures projection optical system PL, in a state where nozzle member 32 surrounds the tip of barrel 40 holding lens 42. Incidentally, the configuration and the like of nozzle member 32 will be described later on.

Stage device 50 is equipped with a wafer stage WST, a wafer stage drive system 24 which drives wafer stage WST and the like. Wafer stage WST is equipped with an XY stage 31, which is placed on a base (not shown) below projection optical system PL in FIG. 1 and is driven in the XY direction by a linear motor and the like (not shown) configuring wafer stage drive system 24, and a Z tilt stage (also referred to as a wafer table) 30, which is mounted on XY stage 31 and is finely driven in the Z-axis direction and a tilt direction (a θx direction and a θy direction) with respect to the XY plane by a Z tilt driving mechanism (not shown) configuring wafer stage drive system 24.

In the center of the upper surface of Z tilt stage 30, a wafer holder (not shown) is arranged which holds wafer W by vacuum suction or the like. In the embodiment, for example, a wafer holder of a so-called pin chuck method on which a plurality of support sections (pin members) supporting wafer W are formed within a loop shaped projecting section (rim section) is used. Incidentally, the wafer holder can be integrally formed with Z tilt stage 30, or can be fixed to the main section (a part excluding a plate which will be described later on) of Z tilt stage 30, by for example, an electrostatic chuck mechanism or a clamping mechanism, or by adhesion and the like.

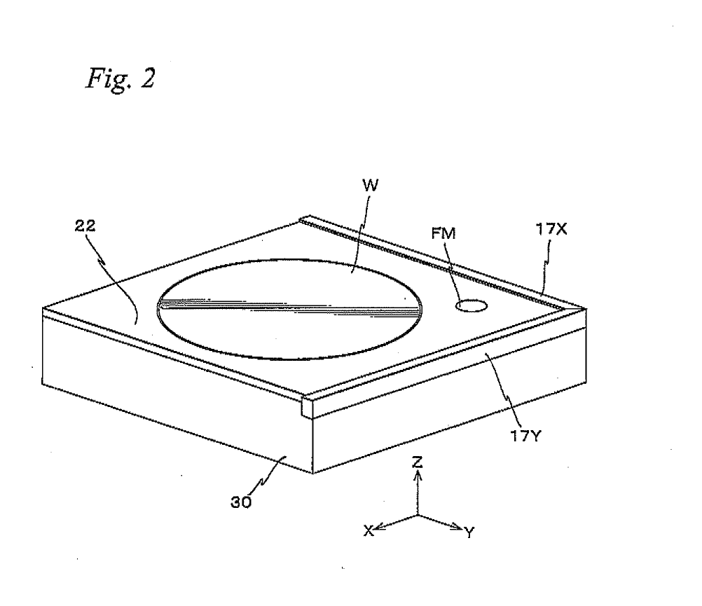

Furthermore, on the upper surface of the main section of Z tilt stage 30, as shown in FIG. 2, a plate (liquid-repellent plate) 22, in the center of which a circular opening that is slightly larger than wafer W (wafer holder) is formed and which has a square or a rectangular outer shape (contour) that corresponds to the main section, is attached on the outer side of the wafer holder (mounting area of wafer W). A liquid repellent treatment against liquid Lq is applied to the surface of plate 22 (a liquid repellent surface is formed). Plate 22 is fixed to the upper surface of main section 80 such that the entire surface (or a part of the surface) of plate 82 is flush with the surface of wafer W. Further, in a part of plate 22, a circular opening is formed, and a fiducial mark plate FM is fitted in the opening, without any gaps. Fiducial mark plate FM has its surface arranged substantially flush with plate 22. On the surface of fiducial mark plate FM, various reference marks (neither are shown) are formed which are used for reticle alignment, baseline measurement of the alignment system (not shown) and the like.

Referring back to FIG. 1, XY stage 31 is configured movable not only in the scanning direction (the Y-axis direction) but also in a non-scanning direction the X-axis direction) orthogonal to the scanning direction, so that shot areas serving as a plurality of divided areas on wafer W can be positioned at the exposure area conjugate with illumination area DAR, and performs a step-and-scan operation in which an operation of scanning exposure (scanning) of each shot area on wafer W and an operation (movement operation between divided areas) of moving to an acceleration starting position (scanning starting position) for exposure of the next shot area are repeatedly performed.

The position (including rotation in the θz direction) of wafer stage WST in the XY plane is constantly detected, for example, at a resolution of around 0.25 [nm], by a wafer laser interferometer (hereinafter referred to as a “wafer interferometer”) 18, via a movable mirror 17 provided on the upper surface of Z tilt stage 30. Now, actually, on Z tilt stage 30, for example, while a Y movable mirror 17Y having a reflection surface orthogonal to the scanning direction (the Y-axis direction) and an X movable mirror 17X having a reflection surface orthogonal to the non-scanning direction (the X-axis direction) are provided as is shown in FIG. 2, and as for wafer interferometers corresponding to these mirrors, an X interferometer which irradiates a measurement beam perpendicularly on X movable mirror 17X and a Y interferometer which irradiates a measurement beam perpendicularly on Y movable mirror 17Y are provided, these are representatively shown as movable mirror 17 and wafer interferometer 18 in FIG. 1. Incidentally, the X interferometer and the Y interferometer of wafer interferometer 18 are both multiaxial interferometers that have a plurality of measurement axes, and by these interferometers, rotation (yawing (rotation in the θz direction), pitching (rotation in the θx direction), and rolling (rotation in the θy direction)) can also be measured other than the X, X positions of wafer stage WST (or to be more precise, Z tilt stage 30). Further, the multiaxial interferometers irradiate laser beams on a reflection plane set on the main frame on which projection optical system PL is mounted via a reflection plane set on Z tilt stage 30 tilted at an angle of 45 degrees, and can also measure the positional information of Z tilt stage 30 in an optical direction (the Z-axis direction) of projection optical system PL.

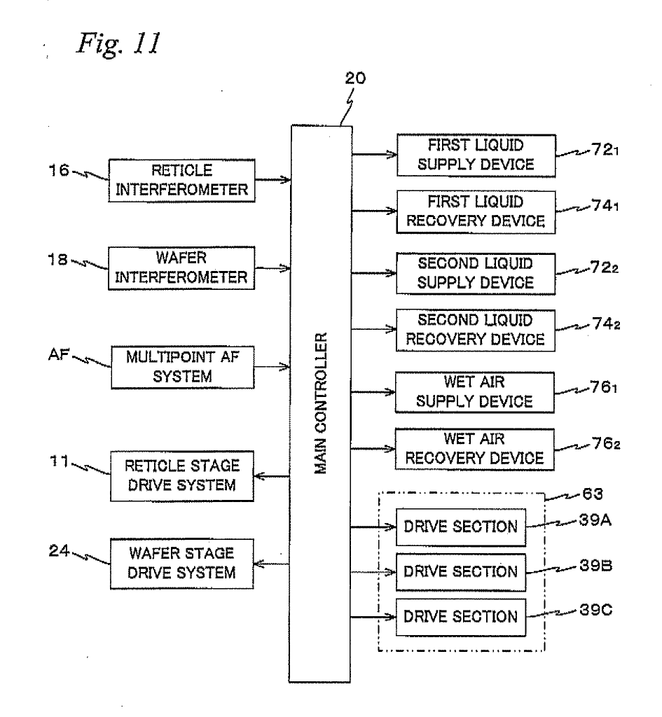

The positional information (or velocity information) of wafer stage WST is supplied to main controller 20 (refer to FIG. 11). Main controller 20 drives wafer stage WST via wafer stage drive system 24, based on positional information (or velocity information) of wafer stage WST.

Moreover, in exposure apparatus 100 of the embodiment, a multiple point focal point position detection system (hereinafter shortly referred to as a multipoint AF system) AF (not shown in FIG. 1, refer to FIG. 11) by the oblique incidence method having a similar configuration as the one disclosed in, for example, U.S. Pat. No. 5,448,332 and the like, is arranged in the vicinity of projection unit ET. Detection signals of multipoint AF system AF are supplied to main controller 20 (refer to FIG. 11) via an AF signal processing system (not shown). Main controller 20 detects positional information (surface position information) of the wafer W surface in the Z-axis direction at a plurality of detection points of the multipoint AF system AF based on detection signals of multipoint AF system AF, and performs a so-called focus leveling control of wafer W during the scanning exposure based on the detection results.

Further, in exposure apparatus 100 of the embodiment, above reticle stage RST, as disclosed in detail in, for example, U.S. Pat. No. 5,646,413 and the like, a pair of reticle alignment systems by an image processing method, each of which uses light with an exposure wavelength (illumination light IL in the embodiment) as illumination light used for alignment, are placed (not shown).

A nozzle unit including nozzle member 32 will now be described. FIG. 3 shows a longitudinal sectional view of the +Y side half of nozzle member 32, with the −Y side half omitted. The reason why the −Y side half was omitted here is because nozzle member 32 has a shape which is rotationally symmetric around an axis (coincides with optical axis AX in the embodiment) parallel to the Z-axis.

As shown in FIG. 1 (and FIG. 3), nozzle member 32 is a annular shaped member provided surrounding tip lens 42 of projection optical system PL, and wafer W (wafer stage WST) is placed facing one side (the bottom surface side) of nozzle member 32. As shown in FIG. 3, nozzle member 32 has a hole section 32f that has a shape of a mortar (conical shape) slightly larger but substantially in the same shape as the outer periphery surface of tip lens 42 where tip lens 42 can be placed in the center.

To three places on the upper surface of (the main body of) nozzle member 32, one end of a roughly L-shaped coupling member (not shown) is fixed, respectively. The other end of these joint members is supported by suspension from a column (separated from the main frame vibration wise) below the main frame supporting projection optical system PL, and is connected to the upper surface of a pair of support plates which are placed in the Y-axis direction with projection unit PU in between. In this case, one coupling member is connected to the center of one of the support plates, and the remaining two coupling members are connected to both ends of the other support plate. And, at a support point of each of the coupling member, for example, drive sections 39A to 39C (refer to FIG. 11) of the voice coil motor method (a motor of an EI core method which is a combination of the E-type core and I-type core is also preferable) is provided. Main controller 20 drives drive sections 39A to 39C, for example, based on measurement values of multipoint AF system AF (refer to FIG. 11). Drive sections 39A to 39C respectively drive (refer to the outlined arrow in FIG. 3) the three joint members independently in the Z-axis direction in predetermined strokes. This allows the position in the Z-axis direction and the angle in the θx and θy directions of nozzle member 32 to be controlled. A nozzle unit is configured including nozzle member 32 and the joint members, and a nozzle drive device 63 (refer to FIG. 11) that controls the position in the Z-axis direction and leveling of the nozzle unit (nozzle member 32) is configured, including support member and drive sections 39A to 39C.

In the embodiment, during exposure of the liquid immersion method and the scanning exposure method, the position and the angle of nozzle member 32 are controlled via nozzle drive device 63 so that a gap (clearance) between the bottom surface of nozzle member 32 and the surface of wafer W is maintained within a predetermined range, such as, for example, 10 to 200 [μm], as in 100 [βm] (0.1 [mm]). Incidentally, in the case the degree of flatness of wafer W is favorable, or when there is little leakage of liquid Lq to the outside of nozzle member 32 (details to be described later), nozzle drive device 63 does not have to be provided, and the nozzle unit simply has to be fixed to the column previously described.

Incidentally, the gap (clearance) between the bottom surface of nozzle member 32 and the surface of wafer W can be maintained by driving nozzle drive device 63 (drive sections 39A to 39C) based on the measurement values of wafer interferometer 18 previously described (or measurement values of a sensor which measures the gap between the bottom surface of nozzle member 32 and the surface of wafer W).

Incidentally, nozzle member 32 can be fixed to the main frame and the like via nozzle drive device 63 and/or the vibration isolating mechanism, or directly to the main frame. Incidentally, in the embodiment, while nozzle member 32 is provided in a column which is separated from the main frame vibration wise, such as in a column which is fixed to the installation surface of the exposure apparatus via the vibration isolating mechanism separate from the main frame, in the case the exposure apparatus in FIG. 1 has a configuration where projection optical system PL is supported by suspension with respect to the column as is previously described, for example, nozzle member 32 can be provided in the frame supported by suspension independently from projection optical system PL.

In between an inner side surface of hole section 32f of nozzle member 32 and the side surface of tip lens 42 of projection optical system PL, a gap is provided to separate tip lens 42 and nozzle member 32 vibration wise. Further, a liquid supply system including nozzle member 32, a liquid recovery system (such as a first and second liquid supply device and a first and second liquid recovery device) and projection optical system PL are each supported by different support mechanisms, and are separated vibration wise. This prevents the vibration generated in the liquid supply system including nozzle member 32 and in the liquid recovery system from travelling to the projection optical system PL side. Further, in the gap between hole section 32f of nozzle member 32 and the side surface of tip lens 42, a seal member (packing) is placed such as a V ring or an O ring which is formed of a material that has only a small amount of metal ion eluting, and the seal member prevents liquid Lq forming the liquid immersion area from leaking from between the gap, as well as prevents gas (bubbles) from mixing in liquid Lq forming the liquid immersion area from the gap. Further, because the seal member of nozzle member 32 has flexibility, nozzle member 32 is allowed to relatively move with respect to tip lens 42 in the Z-axis direction within predetermined strokes.

Nozzle member 32 has a shape of a loop surrounding the optical path of illuminating light IL as shown in FIG. 3, and on a bottom surface 32j to which wafer W is placed facing, concentric double annular recess sections 32n and 32h are formed whose center is optical axis AX. Annular recess section 32n on the inner side divides ring projecting section 32b₁ and ring projecting section 32b₂ which are concentric, and annular recess section 32h on the outer side divides ring projecting section 32b₂ and ring projecting section 32d which are concentric. While details will be described later on, a space 14₂ surrounded by annular recess section 32h and wafer W becomes a second liquid space (an auxiliary liquid immersion space), and a space 14₃ surrounded by annular recess section 32n and wafer W becomes a buffer space.

On the inner bottom surface (the upper surface) of recess section 32h facing wafer W, as shown in FIG. 3, an inclined surface 32c whose direction (spacing) between the surface of wafer W becomes smaller from the inside toward the outside is formed covering the entire periphery. Bottom surface 32j of nozzle member 32, in this case, is a surface on the −Z side of nozzle member 32, and refers to a plane (section) placed close to wafer W via a small clearance (a clearance gap, gap, space) to be described later on, such as, for example, around 0.1 [mm].

In the embodiment, a super water repellency with a contact angle (refer to reference code β in FIG. 6) of 150 degrees or more is given to the surface of inclined surface 32c. In this case, the surface is made to have a minute uneven structure by a polishing treatment such as electrolytic etching, sand blasting and the like, and on the polished surface, for example, a fluorine coating that uses polytetrafluoroethylene (PTFE), namely Teflon (a registered trademark) and the like, is applied. In other words, such a livid repellent processing (super water repellency processing) is applied to inclined surface 32c. However, inclined surface 32c does not necessarily require liquid repellency up to the super water repellency, and only has to have a liquid repellency with a contact angle of 130 degrees or more (this will be described later on).

Nozzle member 32 has an annular shaped (ring shaped) and a plate shaped inner side projection 35 that communicates with the lower end of hole section 32f provided in the inner circumference (the center section). Inner side projection 35 has a circular opening formed in the center which serves as an optical path of illumination light IL penetrating in the Z-axis direction. The periphery of the circular opening faces the periphery section of the lower end surface (outgoing surface) of tip lens 42. In other words, inner side projection 35 extends toward the center until a position facing the periphery section of the lower end surface (outgoing surface) of tip lens 42.

A lower surface 32k of inner side projection 35 is considered to be a ring shaped plane (a surface parallel to the XY plane) having an outer diameter larger than the diameter of the lower end surface of tip lens 42. The distance between lower surface 32k of inner side projection 35 and wafer W is larger than the distance (e.g., 0.1 [mm]) between bottom surface 32j (the lower surface of projecting sections 32b₁, 32b₂ and 32d) and wafer W.

Further, in the outer periphery side on lower surface 32k of inner side projection 35 of nozzle member 32, an upper side guide surface of a slope shape (an arc shaped section) which gradually rises upward toward the outside is formed along the entire periphery. In other words, because lower surface 32k is precisely a part (an extended section) of the upper side guide surface, in the description below, the upper side guide surface will be expressed as an upper side guide surface 32k, using reference code 32k.

As shown in FIG. 3, facing the upper side guide surface 32k, a lower side guide surface 32e of a slope shape (an arc shaped section) which rises upward from the inner edge (inner circumference) of the lower end surface of projecting section 32b₁ toward the outside is formed along the entire periphery.

In the outer periphery section of bottom surface 32j of nozzle member 32, that is, in the outer periphery side of projecting section 32d, a surface with an arc shaped cross section is formed along the entire periphery. Further, an outer periphery surface 32g of nozzle member 32 serves as a cylindrical surface (a surface parallel to optical axis AX along the entire periphery) whose central axis is optical axis AX. However, such an arrangement does not always have to be employed, and for example, the lower surface of projecting section 32d can be a surface parallel to the XY plane, and the outer periphery surface can be a tapered surface (a conical surface) whose upper end is tilted inward, and its surface can be hydrophilic.

On the surface of hole section 32f of nozzle member 32, a supply opening 34a is provided. Supply opening 34a, for example, consists of an opening, and a plurality of openings is provided almost equally spaced along the entire periphery. Supply opening 34a is connected to a liquid supply section 34c typically shown in FIG. 3. Liquid supply section 34c is formed inside of nozzle member 32, and includes at least a liquid supply flow channel including a ring shaped flow channel to which a plurality of supply openings 34a is connected, and the liquid supply flow channel is connected to a first liquid supply device 72₁ (refer to FIG. 11), via one or more supply pipes (not shown), a valve (not shown) and the like. Incidentally, supply opening 34a can be configured of a ring shaped groove section formed along the entire periphery. In this case, the ring shaped flow channel configuring a part of liquid supply section 34c can be configured by the ring shaped groove section.

The first liquid supply device 72₁ includes a tank to house liquid Lq, a temperature controller which adjusts the temperature of liquid Lq to be supplied, a filtering device which removes foreign materials in liquid Lq, and a compression pump and the like which sends out liquid Lq. Incidentally, the first liquid supply device 72₁ does not have to be equipped with all of the tank, the temperature controller, the filtering device, the compression pump and the like, and at least a part of them can also be substituted by the equipment or the like available in the plant where exposure apparatus 100 is installed.

The space between the upper side guide surface 32k and the lower side guide surface 32e of nozzle member 32 is a liquid recovery path 34b₀. In the upper end of liquid recovery path 34b₀, a recovery opening 33a is formed. Recovery opening 33a, for example, consists of an opening, and a plurality of openings is provided almost equally spaced along the entire periphery of the upper end of liquid recovery path 34b₀. Recovery opening 33a communicates with liquid recovery section 34b typically shown in FIG. 3. Liquid recovery section 34b is formed inside of nozzle member 32, and includes at least a liquid recovery flow channel including a ring shaped flow channel to which a plurality of recovery openings 33a is connected, and the liquid recovery flow channel is connected to a first liquid recovery device 74₁, via one or more recovery pipes not shown), a valve (not shown) and the like. Incidentally, recovery opening 33a can be configured of a ring shaped groove section formed along the entire periphery. In this case, the ring shaped flow channel configuring a part of liquid recovery section 34b can be configured by the ring shaped groove section.

The first liquid recovery device 74₁, for example, is equipped with a vacuum system (suction device) such as a vacuum pump, a gas-liquid separator which separates liquid Lq that has been recovered and gas, a tank which houses liquid Lq that has been recovered and the like. Incidentally, as the vacuum system, at least one of a vacuum system such as the vacuum pump, the gas-liquid separator, and the tank can be substituted with the facilities of the factory where the exposure apparatus is installed, without the parts being provided in the exposure apparatus.

Inclined surface 32c previously described formed on the inner bottom surface of recess section 32h of nozzle member 32 is an inclined surface which rises upward toward the inside on the opposite side of upper side guide surface 32k with respect to annular recess section 32n. While the angle of inclination of inclined surface 32c is substantially constant on the inside where the inclined surface is distanced from the surface of wafer W, the angle of inclination gradually becomes smaller on the outside where the inclined surface nears (faces the surface of wafer W via a clearance of, e.g., 0.1 [mm]) the surface of wafer W, and becomes zero at the lower end surface of projecting section 32d. On the outside of projecting section 32b2 facing inclined surface 32c, a slope surface 32m tilted substantially symmetrical to the lower side guide surface 32e is formed along the entire periphery.

In inclined surface 32c, a supply opening 33b is formed in the vicinity of the outer periphery. Supply opening 33b, for example, consists of an opening, and a plurality of openings is provided almost equally spaced along the entire periphery of inclined surface 32c. Each of the supply openings 33b communicates with a liquid supply section 36a typically shown in FIG. 3. Liquid supply section 36a is formed inside of nozzle member 32, and includes at least a liquid supply flow channel including a ring shaped flow channel to which each of the supply openings 33b is connected, and the liquid supply flow channel is connected to a second liquid supply device 72₂ (refer to FIG. 11), via one or more supply pipes (not shown), a valve (not shown) and the like.

In this case, (the outlet part of) supply opening 33b is formed slanting downward toward the inside from the outside, so that liquid Lq supplied from supply opening 33b does not hit wafer W directly, or in other words, so that liquid Lq always hits slope surface 32m. This keeps liquid Lq which has been supplied from damaging the water-repellent coating of wafer W. Incidentally, supply opening 33b can be configured of a ring shaped groove section formed along the entire periphery.

The second liquid supply device 72₂ is configured in a similar manner as the first liquid supply device 72₁ previously described. In this case as well, at least a part of the components configuring the second liquid supply device 72₂ can be substituted by the equipment or the like available in the plant where exposure apparatus 100 is installed.

On the other hand, in the vicinity of the inner periphery section of inclined surface 32c, a recovery opening 33c is formed. Recovery opening 33c, for example, consists of an opening, and openings are provided almost equally spaced along the entire periphery. Recovery opening 33c communicates with liquid recovery section 36b typically shown in FIG. 3. Liquid recovery section 36b is formed inside of nozzle member 32, and includes at least a liquid recovery flow channel including a ring shaped flow channel to which a plurality of recovery openings 33c is connected, and the liquid recovery flow channel is connected to a second liquid recovery device 74₂ (refer to FIG. 11), via one or more recovery pipes (not shown), a valve (not shown) and the like. Incidentally, recovery opening 33c can be configured of a ring shaped groove section formed along the entire periphery.

The second liquid recovery device 74₂ is configured in a similar manner as the first liquid recovery device 74₁. In this case as well, at least a part of the components configuring the second liquid recovery device 74₂ can be substituted by the equipment or the like available in the plant where exposure apparatus 100 is installed.

As it can be seen from FIG. 3, annular recess section 32n previously described, has a cross section that is a chevron ring shaped groove consisting of an inclined surface 32p on the outside and an inclined surface 32r on the inside. At a position (a position at the top of the chevron) on the upper end (the +Z side) of annular recess section 32n of nozzle member 32, a recovery opening 33d is formed. Recovery opening 33d, for example, consists of an opening, and a plurality of openings is provided almost equally spaced along the entire periphery. In the embodiment, each of the recovery openings 33d communicates with liquid recovery section 34b. Incidentally, recovery opening 33d can be configured of a ring shaped groove section formed along the entire periphery.

Alternatively, for example, recovery opening 33d can communicate with liquid recovery section 36b instead of liquid recovery section 34b, and can be connected to the second liquid recovery device 74₂. Or recovery opening 33d can communicate with an independent liquid recovery section (not shown), and can be connected to an independent third liquid recovery device which is configured similar to the first and second liquid recovery devices.

Furthermore, on the edge on the outside of the inclined surface 32c of nozzle member 32, as is shown enlarged in FIG. 4, a slit 33e which is inclined at a predetermined angle with respect to bottom surface 32j parallel to the XY plane is formed along the entire periphery of nozzle member 32. In other words, slit 33e is a ring shaped slit which covers the entire periphery of nozzle member 32.

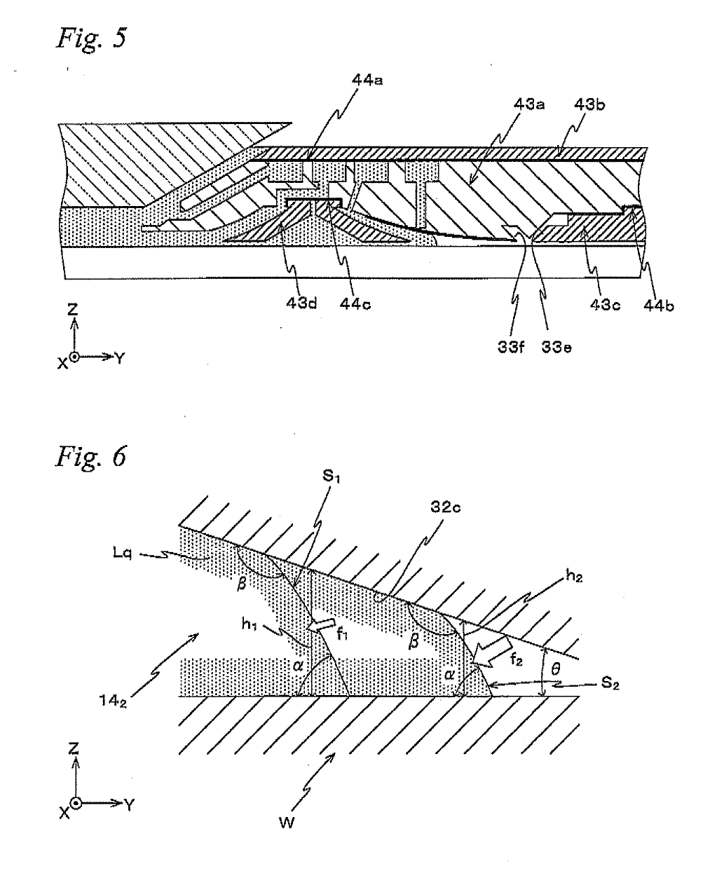

In the embodiment, as an example, nozzle member 32 is configured as shown in FIG. 5, by combining four components 43a to 43d together. In other words, because nozzle member 32 has a rotationally symmetric shape, each of the components 43a to 43d is produced individually, for example, in a turning process, and is welded, for example, by diffusion jointing with weld lines 44a to 44c shown in FIG. 5.

Component 43a consists of a rotationally symmetric loop shaped member which has hole section 32f formed in the center, and includes liquid supply section 34c, liquid recovery section 34b, liquid supply section 36a, and liquid recovery section 36b inside, and supply openings, recovery openings, supply paths, and recovery paths are provided which are connected to these sections, respectively. Further, on a bottom-surface of component 43a, a first recess section whose inner wall surface is the upper side guide surface 32k and inclined surface 32c, and a loop shaped notch on the outer side of the first recess section are formed. In the inner periphery surface of the notch, an inclined surface is formed tilting upward toward the outside from the inside, and in succession with the inclined surface, a flat surface is formed, and in the outer periphery of the flat surface, a stepped section is formed which is recessed to the upper side of the flat surface.

Component 43b consists of a disc shaped plate member which has a circular opening formed in the center, and is fixed to the upper surface of component 43a in a state covering the liquid supply section and liquid recovery section.

Component 43d consists of an annular shaped member having a chevron cross section and annular recess section 32n formed on its bottom surface, and is welded (fixed) to the lower section of component 43a with weld line 44c. By this, liquid recovery path 34b₀ and annular recess section 32h are formed between component 43d and component 43a.

Further, component 43c consists of a ring shaped member, and in the inner periphery surface, an inclined surface is formed tilting downward toward the outside from the inside, and in succession with the inclined surface, a stepped section is formed, and in the vicinity of the outer periphery of the stepped section, a stepped section which is one step higher is formed. Component 43c fits into component 43a from below, and is welded with weld line 44b. This forms slit 33e and a wet air supply section 39a communicating with slit 33e, between component 43c and component 43a. In the embodiment, because slit 33e also serves as a supply opening of wet air supplied via wet air supply section 39a, hereinafter, slit 33e will also be expressed as supply opening 33e. Wet air, here, refers to air having high humidity, with a humidity of 80% to 100%.

Wet air supply section 39a consists of a ring shaped groove section formed along the entire periphery inside nozzle member 32, and is connected to a wet air supply device 76₁ (refer to FIG. 11) via a supply pipe (not shown), a valve (not shown) and the like.

Further, at a position (a position an the inner side of slit 33e) on the outermost periphery of inclined surface 32c of component 43a, a slit 33f tilting downward toward the inside from the outside is formed along the entire periphery of component 43a (nozzle member 32). Because slit 33f also serves as a recovery opening of wet air, hereinafter, slit 33f will also be expressed as recovery opening 33f.

Recovery opening 33f communicates with wet air recovery section 39b typically shown in FIG. 4. Wet air supply section 39b is connected to a wet air recovery device 76₂ (refer to FIG. 11), via a plurality of openings (or a plurality of through-holes), a supply pipe (not shown) connected to each of the plurality of openings (or the plurality of through-holes), a valve (not shown) and the like.

As described above, because nozzle member 32 has a rotationally symmetric shape, each of the components can be produced individually in a turning process, which makes production easy, and because a mesh member does not have to be used, the whole structure is configured a solid, which allows rigidity to be secured.

In exposure apparatus 100 of the embodiment, nozzle member 32 configured in the manner described above is used. Therefore, when liquid Lq is supplied to nozzle member 32 from the first liquid supply device 72₁ (refer to FIG. 3), liquid Lq is supplied into a space (14₁) including the optical path of illumination IL enclosed by tip lens 42 and wafer W in a laminar flow state along an arrow shown in FIG. 3, from supply opening 34a via liquid supply section 34c, via a gap between inner side projection 35 of nozzle member 32 and the lower surface of tip lens 42. This allows space (14₁) to be filled with plenty of liquid Lq whose temperature is controlled with high precision, and a first liquid immersion space (a first liquid space) 14₁ having a uniform temperature distribution 141 is formed.

And this liquid Lq flows through the inside of liquid recovery path 34b₀, and is collected by first liquid recovery device 74₁ via liquid recovery section 34b.

As is previously described, the lower side guide surface 32e configuring liquid recovery path 34b₀ is formed in a slope shape which rises upward from the inner periphery of the lower end surface of projecting section 32b₁ of nozzle member 32 toward the outside, covering the entire periphery. Therefore, in the case wafer W moves in the +Y direction in FIG. 3, for example, liquid Lq filled in the first liquid immersion space 14₁ moves in the +Y direction (a flow is generated in the +Y direction) along with the movement of wafer W due to viscosity of the liquid. However, as is previously described, because bottom surface 32j (in other words, the lower surface of projecting section 32b₁, projecting sections 32b₂ and 32d) is close to wafer W via a small clearance (e.g., around 0.1 [mm]) only a small amount of liquid Lq passes through the clearance and leaks outside of the first liquid immersion space 14₁. Accordingly, almost all the amount of liquid Lq flows inside liquid recovery path 34b₀ along the lower side guide surface 32e (and the upper side guide surface 32k), and flows into liquid recovery section 34b. Liquid Lq within liquid recovery section 34b is recovered by the first liquid recovery device 74₁.

As is obvious from the description so far, when liquid Lq is supplied from supply 34a, liquid Lq flows inward into the upper part of the first liquid immersion space 14₁ along the arrow shown in FIG. 3, via the gap between inner side projection 35 of nozzle member 32 and the lower surface of tip lens 42, changes a direction of the flow downward (the −Z direction) inside the first liquid immersion space 14₁, flows outside from the lower part of the first liquid immersion space 14₁, passes through liquid recovery path 34b₀ and is recovered by liquid recovery section 34b. In other words, liquid Lq flows almost in a laminar flow state from supply opening 34a to liquid recovery section 34b, according to the shape in the vicinity of liquid recovery path 34b₀ of nozzle member 32.

In this case, the position in the z-axis direction and leveling of nozzle member 32 are controlled by nozzle drive device 63 previously described, and the gap (clearance) between the bottom surface and the surface of wafer W, or in other words, the clearance is maintained to be around 0.1 [mm], regardless of the Z position (and inclination) of wafer stage WST. This allows liquid Lq to be shut inside the first livid immersion space 14₁ without liquid Lq hardly leaking (only a small leak).

In the liquid immersion exposure, illumination light IL emitted from tip lens 42 of projection optical system PL is irradiated on wafer W mounted on wafer stage WST via (liquid Lq filled in) the first liquid immersion space 14₁. This allows a pattern formed on reticle R to be transferred on wafer W. In the embodiment, as liquid Lq, ultrapure water (hereinafter, simply referred to as “water” besides the case when specifying is necessary) that transmits the ArF excimer laser light (light with a wavelength of 193.3[nm]) is to be used. Refractive index n of the water is around 1.47. In this water, illumination light IL is 193 [nm]×1/n, shorted to around 131 [nm]

The reason for using ultrapure water as liquid Lq is because ultrapure water can be obtained in large quantities at a semiconductor manufacturing plant or the like without difficulty, and it also has an advantage of having no adverse effect on the photoresist on the wafer, to the optical lenses and the like. In addition, ultrapure water does not have any adverse effects on the environment, and because content of impurities is extremely low, a washing effect of the surface of wafer W and the surface of tip lens 42 can also be expected.

When liquid Lq is supplied from the second liquid supply device 72₂, liquid Lq passes through liquid supply section 36a, and is supplied along the arrow shown in FIG. 3 and inwardly into a space (14₂) from supply opening 33b. This allows space (14₂) to be filled with liquid Lq, and a second liquid immersion space (a second liquid space) 14₂ is formed.

Recovery opening 33c is located at the inner periphery of recess section 32h, or namely, the upper end of the outer periphery surface of projecting section 32b₂. Further, as is previously described, liquid Lq, which is obliquely supplied from supply opening 33b from the outside toward the inside, hits slope surface 32m without fail. Accordingly, liquid Lq which is supplied inwardly into space (14₂) changes the direction of the flow according to the arrow shown in FIG. 3, and flows into liquid recovery section 36b along an outer periphery surface (an outer wall surface) of projecting section 32b₂, via recovery opening 33c. Liquid Lq within liquid recovery section 36b is recovered by the second liquid recovery device 74₂.

By the configuration of nozzle member 32 described above, the first liquid immersion space (liquid space) 14₁ is formed between projection optical system PL and wafer W, and further, the second liquid immersion space (liquid space) 14₂ is formed surrounding the first liquid immersion space 14₁. In the inside of the second liquid immersion space 14₂, a flow of liquid Lq is formed which keeps liquid Lq that has flown inside from passing through the gap between nozzle member 32 and wafer W and leaking outside.

Therefore, even if the liquid leaks into the second liquid immersion space 14₂ via the clearance between projection section 33b₁ and wafer W and the clearance between projection section 33b₂ and wafer W from the first liquid immersion space 14₁, the leakage of this liquid is effectively suppressed by the shape and liquid repellency of inclined surface 32 inside the second liquid immersion space 14₂, the flow of liquid Lq inside the second liquid immersion space 14₂ and the like.

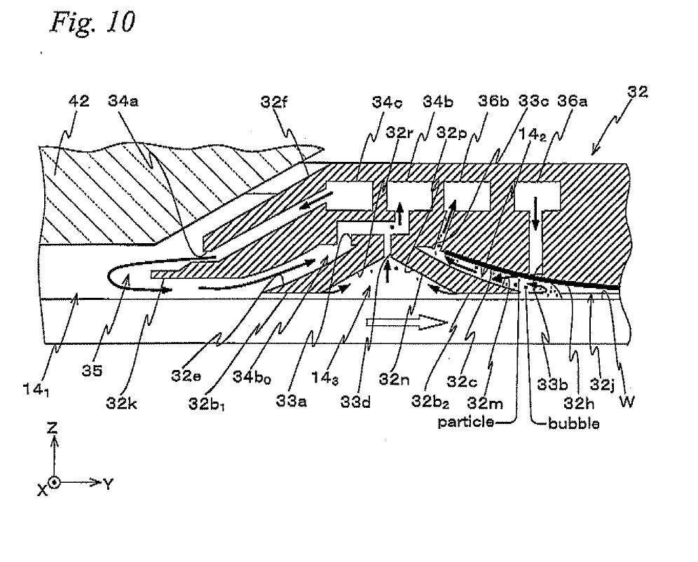

Further, the flow of liquid Lq which has flown into space (14₂) via the clearance between the lower surface of projecting section 32b₂ and the surface of wafer W becomes a laminar flow state, and for its viscosity, separation occurs in the boundary layer of the flow of liquid Lq with the lower surface of projection section 32b₂, and a vortex is generated, as shown in FIG. 10. By this vortex, air bubbles and particles that are in liquid. Lq at the outer side (an entrance side of space (14₂)) of the outer periphery of projecting section 32b₂ are trapped in this vortex, and flows along slope surface 32m along with liquid Lq and then into liquid recovery section 36b, via recovery opening 33c which is positioned at an upper end of slope surface 32m. Liquid Lq within liquid recovery section 36b is recovered by the second liquid recovery device 74₂. In other words, objects which become factors of defects such as the air bubbles and the particles in liquid Lq within the second liquid immersion space 14₂ are recovered immediately within the second liquid immersion space 14₂. Incidentally, it is desirable to obtain the optimal flow of the liquid within the second liquid immersion space 14₂ to achieve a high recovery efficiency of particles (and bubbles) and the like, that is to say, for example, to obtain a shape of slope surface 32m, angle of inclination of the outlet portion of supply opening 33b, a supply flow rate and the like to achieve the optimal flow by simulation and the like. Further, the principle of liquid Lq being enclosed inside of the second liquid immersion space 14₂ will be described further, later in the description.

Further, liquid Lq supplied into the second liquid immersion space 14₂ from supply opening 33b could sometimes flow toward the first liquid immersion space 14₁ via the clearance between projecting section 33b₂ and wafer W. However, in the embodiment, recess section 32n is formed between projecting section 33b₂ and projecting section 33b₁, and a buffer space (a third liquid space) 14₃ is formed between recess section 32n and wafer W (refer to FIG. 3). Further, at a position on the upper side of buffer space 14₃ of nozzle member 32, recovery opening 33d communicating with liquid recovery section 34b is provided. Therefore, liquid Lq which has leaked into buffer space 14₃ from the second liquid immersion space 14₂ is collected by the first liquid recovery device 74₁, via recovery opening 33d. Accordingly, even if liquid Lq including particles and/or air bubbles and the like enters buffer space 143 from the second liquid immersion space 14₂, particles and/or air bubbles are collected by the first liquid recovery device 74₁ along with liquid Lq. Liquid Lq which has leaked into buffer space 14₃ from the first liquid immersion space 14₁ is also recovered by the first liquid recovery device 74₁.

Further, in the embodiment, while there is a section (an interface between air and liquid Lq) where air and liquid Lq are in contact inside the clearance between the bottom surface of nozzle member 32 and wafer w, because the clearance above is maintained at around 0.1 [mm], the area of the interface between air and liquid Lq is extremely small. Further, air flow is not present around the interface. This suppresses generation of the heat of evaporation. Furthermore, in the embodiment, wet air is supplied to wet air supply section 39a inside of nozzle member 32 from a wet air supply device 76₁ (refer to FIG. 11). And as shown in FIG. 4, this wet air is supplied into space (14₂) by supply 33e provided along the entire periphery on the edge outside of inclined surface 32c of nozzle member 32. This allows the space around the interface to be purged. Further, because, recovery openings 33a and 33c, and supply openings 34a and 33b of liquid Lq are not in contact with gas, the heat of evaporation is not generated on recovery and supply of liquid Lq. Accordingly, in the embodiment, generation of vaporization (evaporation) of liquid Lq on wafer W is almost completely prevented, which substantially keeps distortion of wafer W due to the heat of evaporation of liquid Lq from occurring.

In the embodiment, because buffer space 14₃ keeps liquid Lq from flowing between the first liquid immersion space 14₁ and the second liquid immersion space 14₂, as liquid Lq supplied from the second liquid supply device 72₂, by using a liquid whose temperature is higher than liquid Lq supplied from the first liquid supply device 72₁, the temperature of liquid Lq filled within the second liquid immersion space 14₂ can be made higher than the first liquid immersion space 14₁ and inside buffer space 14₃. This allows the generation of distortion of wafer W due to vaporization (evaporation) of liquid Lq in the second liquid immersion space 14₂ to be suppressed.

By the purge of wet air described above, liquid Lq is confined without fail in the second liquid immersion space 14₂. In other words, supply of wet air from supply opening 33d to space (14₂) can be performed in order to confine liquid Lq.

Further, the excess wet air supplied to the space which is purged described above is collected by wet air recovery device 76₂ (refer to FIG. 11) connected to wet air recovery section 39b, via recovery opening 33e. This prevents a situation such as the wet air flowing outside of nozzle member 32 from occurring.

Next, a principle of liquid Lq being confined inside of the second liquid immersion space 14₂ will be described, referring to FIGS. 6 to 9E.

By the liquid repellent treatment previously described, the surface of inclined surface 32c has contact angle 3 shown in FIG. 6 set, for example, to around 150 degrees or more.

Incidentally, in order to effectively confine liquid Lq, a liquid repellent treatment is to be applied which shows a contact angle β equal to or more than the sum of angle of inclination θ of inclined surface 32c (an angle formed by inclined surface 32c and the surface of wafer W) and 90 degrees.

On the other hand, as for wafer W exposed by liquid immersion exposure as well, a liquid repellent coating is applied on a resist film, or a resist film is formed using a topcoat-less resist having liquid repellency. Therefore, the surface of wafer W has a liquid repellency showing a contact angle (an angle α in FIG. 6) of, for example, 60 degrees or more.

As shown in FIG. 6, when liquid Lq enters the air gap between inclined surface 32c and the surface of wafer W that have liquid repellency, liquid Lq comes into contact with inclined surface 32c at contact angle β, and comes into contact with the surface of wafer W at contact angle α. Therefore, the surface (a boundary surface with air) of liquid Lq curves outward in a projecting manner (a direction to the right in the page surface of FIG. 6).

On the curved liquid surface, a surface tension acts in a direction to make the liquid surface small. For example, when liquid Lq reaches a position, of inclined surface 32c where the height from the surface of wafer W is h₁, or in other words, liquid Lq enters the gap between the surface of wafer W and the surface of inclined surface 32c until liquid Lq reaches a position where gap h=h₁, an inward surface tension f₁ shown by an outlined arrow acts on its surface S₁. Further, when liquid Lq enters further to a position where gap h=h₂, inward surface tension f₂ shown by an outlined arrow acts on its surface S₂. In this case, the surface tension is larger when the curve of the surface is large. Because h₂<h₁, the curve of surface S₂ is larger than the curve of surface S₁. Therefore, on surface S₂, a surface tension f₂ (>f₁) acts, which is larger than surface tension f₁ acting on surface S₁. In other words, a surface tension which is strong in a direction pushing back liquid Lq acts on liquid Lq when liquid Lq enters further into the air gap between the surface of inclined surface 32c and the surface of wafer W.

A necessary condition for liquid Lq to be pushed back by the surface tension, or in other words, for liquid Lq to be held to between recess section 32h and the wafer W surface (in the second liquid immersion space 142), is shown in formula (1) below.

cos α+cos(β−θ)<0;α+β−θ>π (1)

If θ=0, when it is assumed that α=60 degrees, then it is necessary that β>120 degrees.

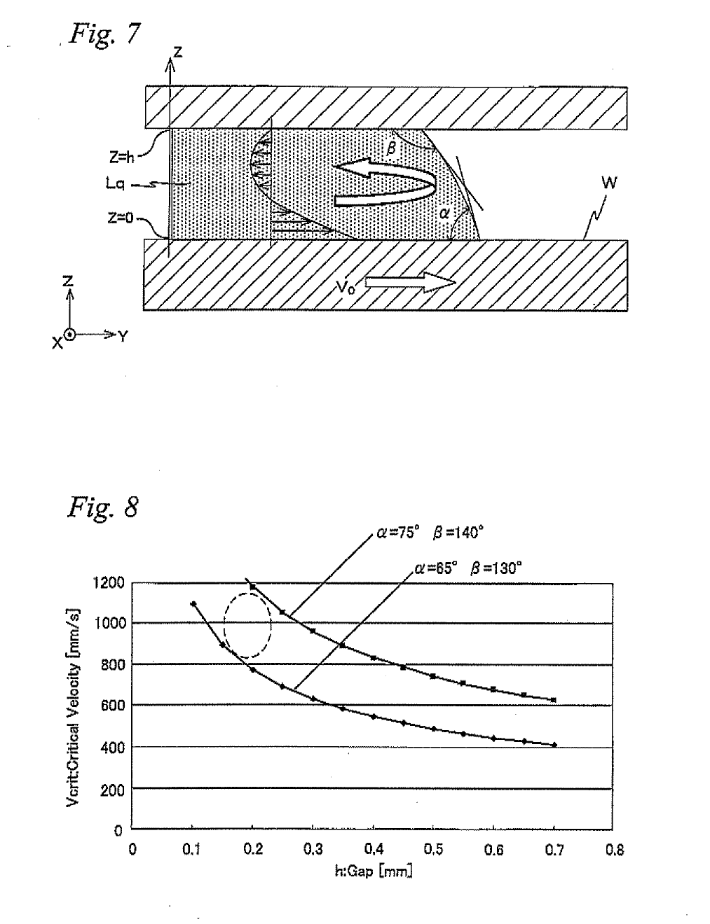

Now, a sufficient condition for liquid Lq to be held between recess section 32h and the wafer W surface (inside the second liquid immersion space 14₂), or in other words, a condition (critical velocity of wafer W) for liquid Lq to be held in between recess section 32h and the wafer W surface (inside the second liquid immersion space 14₂) even if wafer W moves, will be described. In this case, θ=0 so as to simplify the explanation. FIG. 7 shows a velocity distribution of liquid Lq in a height direction (the Z-axis direction) in the case wafer W moves in the +Y direction at a velocity V₀.

Velocity V at an arbitrary Z position in this case can be obtained as in formula (2) below, by solving a parallel flat plate flow when the total sum of velocity Σ Vdz=0, with V=V₀ at a boundary condition Z=0, and also V=0 at Z=h.

$$V = \frac{3 {V}_{0}}{{h}^{2}} ( Z - h ) ( Z - h / 3 ) \qquad ( 2 )$$

Momentum reaction force of liquid Lq received at the interface can be obtained as is shown in formula (4), by performing a calculation of substituting V of formula (2) into V (Z) of formula (3) below. In formula (4), ρ is the density of liquid Lq.

$$\begin{matrix}{F}_{w} = {\int }_{0}^{h} ρ {V ( Z )}^{2} d Z & ( 3 ) \\ {F}_{w} = \frac{2}{15} ρ {V}_{0}^{2} h & ( 4 )\end{matrix}$$

When considering the balance of momentum reaction force F_{w} and the surface tension, it can be expressed as formula (5) below. In formula (5), γ is the surface tension of liquid Lq.

F_{w}=−γ(cos α+cos β) (5)

When the formulas above are solved, critical velocity V_{crit} expressed as in formula (6) below is obtained.

$$Vcrit = \sqrt{\frac{- 15 γ ( cos α + cos β )}{2 ρ h}} \qquad ( 6 )$$

FIG. 8 shows an example of a result when obtaining critical velocity V_{crit} [mm/s] in a range of gap h=0.1-0.7 [mm]. As it can also be seen from FIG. 8, in the case of applying a high water repellent coating with a contact angle of 130 degrees or more to inclined surface 32c, if gap h is set to 0.2 [mm] or less, it can be seen that tolerance of high scanning can be achieved even if the angle of inclination θ of inclined surface 32c is zero, or θ=0. However, because θ>0, in the case of the embodiment, the contact angle of inclined surface 32c can be 130 degrees or less, and for example, by setting angle of inclination θ appropriately taking into consideration contact angle α of the wafer surface, contact angle β of around 120 degrees or more is enough. In the case of the embodiment, when the contact angle of inclined surface 32c is 130 degrees or more, liquid Lq can be held securely between recess section 32h and the wafer W surface (within the second liquid immersion space 14₂).

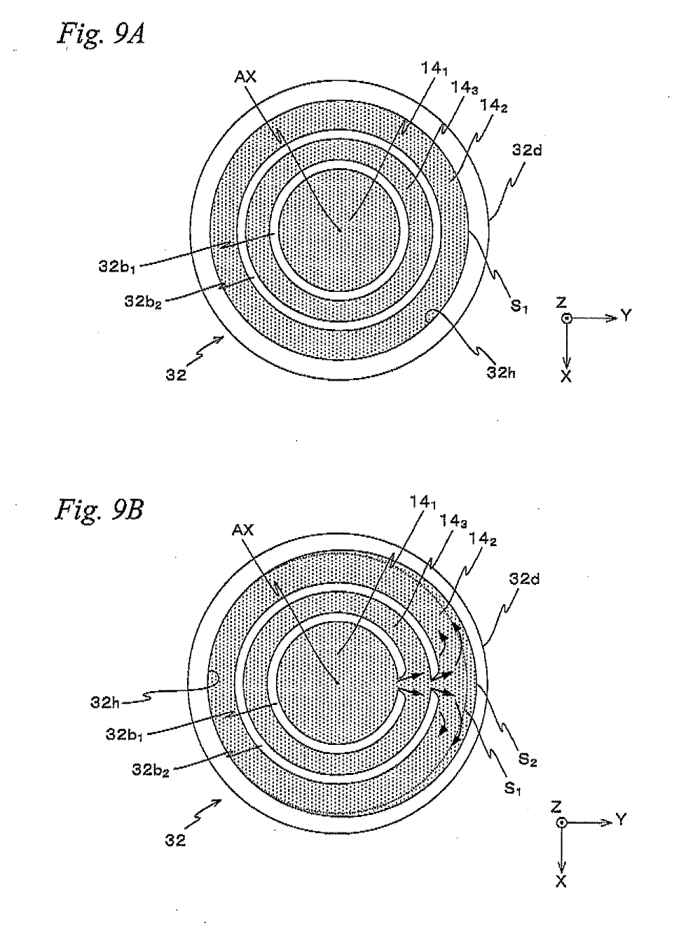

Furthermore, as it can be seen from the simplified bottom surface view of nozzle member 32 shown in FIG. 9A, by the configuration in the vicinity of recess section 32h of nozzle member 32, because recess section 32h which forms the second liquid immersion space 14₂ has a ring-like shape, liquid Lq which has entered the air gap between, the surface of inclined surface 32c and the surface of wafer W and has been pushed back flows in the circumference direction of recess section 32h.

Now, as shown in FIG. 9B, suppose that wafer W (wafer stage WST) moves in the +Y direction, and with this movement, liquid Lq flows out (leaks out) along the arrow to the second liquid immersion space 14₂ from buffer space 14₃, passing through the extremely small clearance between projecting section 32b₂ and the surface of wafer W. Incidentally, in FIG. 9B (and FIG. 9A), illustration of the arrow showing a flow of liquid Lq in a normal state (the state shown in FIG. 3) is omitted.

Because liquid Lq flows into the second liquid immersion space 14₂, the outer periphery of the second liquid immersion space 14₂ expands in the +Y direction, and liquid Lq enters an air gap between the surface of inclined surface 32c and the surface of wafer W. However, because liquid Lq is pushed back by the surface tension as is described above, liquid Lq goes around to a circumferential direction of the second liquid immersion space (recess section) 14₂. This makes the second liquid immersion space 14₂ become slightly larger than normal, and as a whole, moves in the +Y direction.

Furthermore, the amount of flow of liquid Lq which has flown into the second liquid immersion space 14₂ from buffer space 14₃ is recovered by the second liquid recovery device 74₂ (refer to FIG. 11) from the second liquid immersion space 14₂. Further, in the case liquid Lq spreads to the outer periphery side in the second liquid immersion space 14₂, because liquid Lq enters into slit 33e, the spreading of liquid Lq stops naturally at a position of slit (recovery opening) 33e. This keeps liquid Lq from leaking to the outer side of projecting section 32d of nozzle member 32 via the air gap between projecting section 32d and the surface of wafer W even if liquid Lq leaks out from buffer space 14₃ to the second liquid immersion space 14₂, and liquid Lq is confined to the inner side of the second liquid immersion space 14₂.

FIG. 11 shows a block diagram showing an input/output relation of main controller 20, which centrally configures a control system of exposure apparatus 100 and has overall control over each part. Main controller 20 includes a work station (or a microcomputer), and has overall control over each component of exposure apparatus 100, including the first liquid supply device 72₁, the first liquid recovery device 74₁, the second liquid supply device 72₂, the second liquid recovery device 74₂, and nozzle drive device 63.

In exposure apparatus 100 of the embodiment, predetermined preparatory operations are performed similar to a normal scanning stepper, such as loading reticle R onto reticle stage RST, loading wafer W onto wafer stage WST, detecting reference marks (not shown) on fiducial mark plate FM using the reticle alignment system (not shown) and the wafer alignment system (not shown) previously described, reticle alignment and baseline measurement of the alignment system and the like.

Then, when wafer alignment using the wafer alignment system has been completed, main controller 20 begins the exposure operation by the step-and-scan method, and a circuit pattern of reticle R is sequentially transferred onto the plurality of divided areas (shot areas) on wafer W. The exposure operation by the step-and-scan method is performed by alternately repeating the scanning exposure operation to the shot areas on wafer W and a movement operation (a stepping operation) between shot areas.

Of the operations described above, reticle alignment and the scanning exposure operation is performed by a liquid immersion method. Further, during the scanning exposure described above, main controller 20 measures the surface position (and tilt) of wafer W using multipoint AF system (not shown) and the like to make the illumination area on wafer W substantially coincide with the image forming plane of projection optical system PL, and performs auto focusing, auto leveling and the like, based on the measurement information. Further, in order to confine liquid Lq to the inner side of the second liquid immersion space 14₂, main controller 20 finely drives nozzle member 32 in the Z-axis direction via nozzle drive device 63 according to the measurement values of wafer interferometer 18, and maintains a predetermined clearance (e.g. around 0.1 [mm]) between bottom surface 32j of nozzle member 32 and the surface of wafer W.

And, when the scanning exposure to the plurality of shot area on wafer W is completed in the manner described above, main controller 20 moves wafer stage WST to a predetermined scrum position. Main controller 20 makes a movable member (not shown) such as another stage (e.g. a measurement stage which will be described later on) or a plate member approach wafer stage WST, and by driving wafer stage WST and the movable member while maintaining a proximity state (a scrum state), delivers liquid Lq (liquid Lq held in the inner side of the second liquid immersion space 14₂) held on wafer stage WST (wafer W) onto the movable member (not shown).

After the delivery, main controller 20 moves wafer stage WST to a predetermined wafer exchange position, and performs a wafer exchange. After the wafer exchange, wafer stage WST is made to approach the movable member (not shown), and wafer stage WST and the movable member are driven in a direction opposite to the direction earlier while maintaining the scrum state, and delivers liquid Lq (liquid Lq held in the inner side of the second liquid immersion space 14₂) held on the movable member to wafer stage WST. After the delivery, wafer alignment and exposure by the step-and-scan method are performed in a similar manner to the wafer which has been exchanged.

Now, with nozzle member 32, from the viewpoint of preventing contamination, it is desirable to regularly clean the places especially where contaminants are likely to adhere, or more specifically, parts such as recess section 32h where a dry and a wet state repeatedly occur.

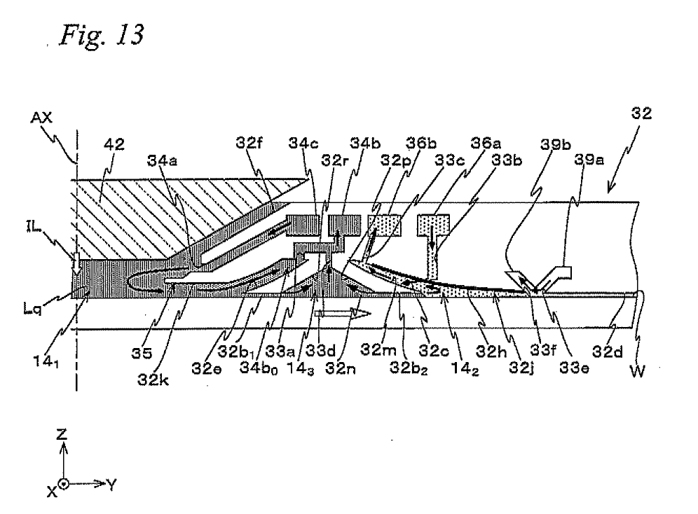

In exposure apparatus 100 of the embodiment, an alkaline solution is used as a cleaning solution for cleaning nozzle member 32. In exposure apparatus 100, as shown in FIG. 13, an alkaline solution is supplied into space (14₂) from liquid supply section 36a via supply opening 33b, and is recovered by the second liquid recovery device 74₂ passing through liquid recovery section 36b via recovery opening 33c. In this case, a configuration in which liquid Lq and the alkaline solution can be selectively supplied to liquid supply section 36a from the second liquid supply device 72₂ can be employed, or a configuration in which a supply device different from the second liquid supply device 72₂ is provided for a cleaning solution, and liquid Lq and the alkaline solution are supplied to liquid supply section 36a from the two liquid supply devices, respectively, can also be employed.

In this case, to fill the entire area (to the position of slit 33d) within the second liquid immersion space 14₂ with the alkaline solution so as to clean the entire area of the inner bottom surface of recess section 32h, or more particularly, to fill the second liquid immersion space 14₂ with the alkaline solution, for example, an HMDS wafer to which a surface treatment is applied using HMDS can be used. HMDS (hexamethyldisilazane) is a colorless transparent liquid, and is coated on the surface of the wafer in general for the purpose of improving contact angle of the surface of the wafer to promote the adhesion of the resist to the wafer, such as for example, changing the surface of the wafer frame hydrophilic nature to a hydrophobic nature. Accordingly, when an HMDS wafer is used, although the alkaline solution spreads to the inner periphery side and the outer periphery side on the HMDS wafer, because the alkaline solution to the outer periphery side of liquid Lq along the inclined surface 32c (an inner bottom surface 32h) enters the inside of slit 33e, the spreading of the alkaline solution toward the outside stops naturally at a position of slit (recovery opening) 33e. In this case, by supplying wet air into space (14₂) from supply opening 33d and purging the space around the interface, the alkaline solution can be held within the second liquid immersion space 14₂ (in a constant shape). Further, also during the cleaning, holding (supply and recovery) of liquid Lq in the first liquid immersion space 14₁ can continue to be performed. Further, by fine adjustment of the supply flow and/or the recovery pressure of the alkaline solution supplied into the second liquid immersion space 14₂, and/or the vertical position of nozzle member 32, it becomes possible to adjust the expansion and reduction of the extent of diameter of the alkaline solution within the second liquid immersion space 14₂.

As described above so far, according to exposure apparatus 100 of the embodiment, the apparatus is equipped with nozzle member 32 having a shape of a loop around the optical path of illumination light IL. Nozzle member 32 is placed in a state where its bottom surface forms a predetermined clearance, such as for example, around 0.1 [mm], with the wafer W surface. Further, liquid Lq is supplied to the inside of nozzle member 32 from the first liquid supply device 72₁ via supply opening 34a, and the first liquid immersion space 14₁ is formed between tip lens 42 and wafer W, and liquid Lq inside of the first liquid immersion space 14₁ is recovered by the first liquid recovery device 74₁ via recovery opening 33a and liquid recovery section 34b. At this point, main controller 20 controls the first liquid supply device 72₁ and the first liquid recovery device 74₁ so that the quantity of liquid Lq supplied into the first liquid immersion space 14₁ and the quantity of liquid Lq recovered from the first liquid immersion space 14₁ coincides as much as possible, which always allow a constant amount of liquid Lq (always replaced) to be held within the first liquid immersion space 14₁. And, the plurality of shot areas on wafer W is exposed with illumination light IL (an image light flux of a pattern of reticle R), via tip lens 42 and liquid Lq inside of the first liquid immersion space 14₁. This allows an image of the pattern of reticle R to be transferred with a high resolution on the plurality of shot areas on wafer W.

Further, in nozzle member 32, bottom surface 32j is placed facing wafer W via a clearance of around 0.1 mm, and on the bottom surface, concentric double annular recess sections 32n and 32h whose center is optical axis AX are formed. And, on the inner bottom surface of annular recess section 32h on the outer side facing wafer W, inclined surface 32c whose direction (spacing) between the surface of wafer W becomes smaller from the inside toward the outside is formed. Furthermore, on the edge on the outer side of inclined surface 32c, an annular shaped slit 33e tilted with respect to bottom surface 32j parallel to the XY plane is formed. Further, inside space (14₂) between recess section 32h and wafer W, the second liquid immersion space 14₂ is formed by liquid Lq supplied from supply opening 33b, and inside the second liquid immersion space 142, a flow of liquid Lq is formed which suppresses the leakage of liquid Lq that has flown inside to the outside passing through the gap between nozzle member 32 and wafer W. Further, the spreading of the liquid along inclined surface 32c stops at the position of slit 33e. This allows the liquid to be confined to the inner side of slit 33e.

Accordingly, even if the liquid leaks into the second liquid immersion space 14₂ via the clearance between projection section 33b₁ and wafer W and the clearance between projection section 33b₂ and wafer W from the first liquid immersion space 14₁, this liquid is effectively suppressed from leaking by the shape and liquid repellency of inclined surface 32 inside the second liquid immersion space 14₂, the flow of liquid Lq inside the second liquid immersion space 14₂ and the like. By this, an air curtain and the like does not have to be used, and a porous member such as a mesh member will not have to be used to recover the liquid inside of the first liquid immersion space 14₁. Accordingly, defects due to the contaminants adhering on the porous member do not occur, which solves various kinds of inconveniences of the apparatus that occur due to the exchange of the contaminated porous member. In other words, decreasing the downtime, improving the throughput, and furthermore, reducing the cost become possible. Further, unlike the case when an air curtain and the like is used, distortion and the like of the wafer caused by the heat of evaporation will not occur. Furthermore, the liquid remaining on wafer W due to the leakage of liquid Lq outside of nozzle member 32 can be substantially prevented.

In the embodiment, in the flow of liquid Lq which has flown into space (14₂) via the clearance between the lower surface of projecting section 32b₂ and the surface of wafer W from the first liquid immersion space 14₁ side, separation occurs in the boundary layer with the lower surface of projection section 32b₂ due to the reasons previously described, and a vortex is generated (refer to FIG. 10). By this vortex, the air bubbles and particles that are in liquid Lq at the entrance side of space (14₂) are trapped, flow along slope surface 32m with liquid Lq and then flow into liquid recovery section 36b via recovery opening 33c, and are finally recovered by the second liquid recovery device 74₂. In other words, objects which become factors of defects such as the air bubbles and the particles in liquid Lq within the second liquid immersion space 14₂ are recovered immediately within the second liquid immersion space 14₂.

Further, liquid Lq is supplied to space (14₂) formed between recess section 32h of nozzle member 32 and wafer W from the second liquid supply device 72₂ via supply opening 33b, and liquid Lq is recovered from space (14₂) by the second liquid recovery device 74₂ via recovery opening 33c. This fills space (14₂) with liquid Lq, and the second liquid immersion space 14₂ which surrounds the first liquid immersion space 14₁ (and buffer space 14₃) is formed. Therefore, even if liquid Lq leaks from the first liquid immersion space 14₁ and flows into the second liquid immersion space 14₂ via buffer space 14₃, liquid Lq becomes a part of liquid Lq in the second liquid immersion space 14₂, and is recovered by the second liquid recovery device 74₂. In this case, inside the second liquid immersion space 14₂, a flow (refer to FIG. 3) of liquid Lq is formed that suppresses the leakage of liquid Lq, which has flown in from the first liquid immersion space 14₁ via buffer space 14₃, to the outside passing through the gap between nozzle member 32 and wafer W. Furthermore, to inclined surface 32c, a liquid repellent treatment is applied so that the contact angle becomes equal to or more than the sum of the angle of inclination to wafer W and 90 degrees. This can prevent liquid Lq from leaking outside of the second liquid immersion space 14₂ more effectively, and can also prevent the liquid from remaining on wafer W due to the leakage of liquid Lq outside of nozzle member 32 more effectively.

Supply opening 33b (around the outlet) is formed from the outside toward the inside so that liquid Lq supplied from supply opening 33b hits slope surface 32m. This avoids a situation such as liquid Lq directly hitting wafer W and damaging the water-repellent coating on wafer W. Because liquid Lq supplied from supply opening 33b is made to hit slope surface 32m, air bubbles and particles trapped by the vortex generated around the interface described above are not disturbed by the supply of liquid Lq from supply opening 33b, and the flow of liquid Lq including the air bubbles and the particles can also be made to head toward recovery opening 33c efficiently. However, slope surface 32m does not necessarily have to be provided. Depending on the shape of supply opening 33b, and/or the amount of supply of liquid per unit time via supply opening 33b, in some cases damage of the water-repellent coating may not have to be considered. Even if slope surface 32m is not provided, the second liquid immersion space 14₂ surrounding the first liquid immersion space 14₁ is formed. Therefore, even if liquid Lq flows into the second liquid immersion space 14₂ from the first liquid immersion space 14₁ via the buffer space, liquid Lq becomes a part of liquid Lq in the second liquid immersion space 14₂, and is recovered by the second liquid recovery device 74₂.

Further, for example, such as when wafer W (wafer stage WST) moves in the −Y direction, liquid Lq including air bubbles and particles inside the second liquid immersion space 14₂ may pass through a small clearance (e.g. around 0.1 [mm]) between projecting section 32b₂ and wafer W and leak out to the first liquid immersion space 14₁. In such a case, in the embodiment, liquid Lq changes the direction of the flow according to the arrow shown in FIG. 10 to recovery opening 33d inside buffer space 14₃ before reaching the first liquid immersion space 14₁, and is recovered by the first liquid recovery device 74₁ via recovery opening 33d. In other words, even if objects which become factors of defects such as the air bubbles and the particles in liquid Lq within the second liquid immersion space 14₂ leak out to the inside, the objects are recovered before reaching the first liquid immersion space 14₁. Further, on the other hand, even in the case liquid Lq in the first liquid immersion space 14₁ leaks outside when wafer W moves in the +Y direction and the like, at least a part of Lq can be recovered inside buffer space 14₃ via recovery opening 33d. This can suppress the leakage of liquid Lq from the first liquid immersion space 14₁ to the second liquid immersion space 14₂, via buffer space 14₃.

Further, in exposure apparatus 100, as shown in FIG. 13, while parts such as recess section 32h are cleaned by supplying an alkaline solution to space (14₂) from liquid supply section 36a via supply opening 33b, during the cleaning, the spreading of the alkaline solution toward the outside to the outer periphery side of liquid Lq along inclined surface 32c (inner bottom surface 32h) can be stopped naturally at a position of slit (supply opening) 33e.

Furthermore, in the embodiment, when wet air is supplied to wet air supply section 39a inside of nozzle member 32 from a wet air supply device 76₁ (refer to FIG. 11), the wet air is supplied into space (14₂) from supply opening 33e, as shown in FIG. 4. This allows the space around the interface to be purged. Further, because, recovery openings 33a and 33c, and supply openings 34a and 33b of liquid Lq are not in contact with gas, the heat of evaporation is not generated on recovery and supply of liquid Lq. Accordingly, in the embodiment, generation of vaporization (evaporation) of liquid Lq on wafer W is almost completely prevented, which substantially keeps distortion of wafer W due to the heat of evaporation of liquid Lq from occurring.

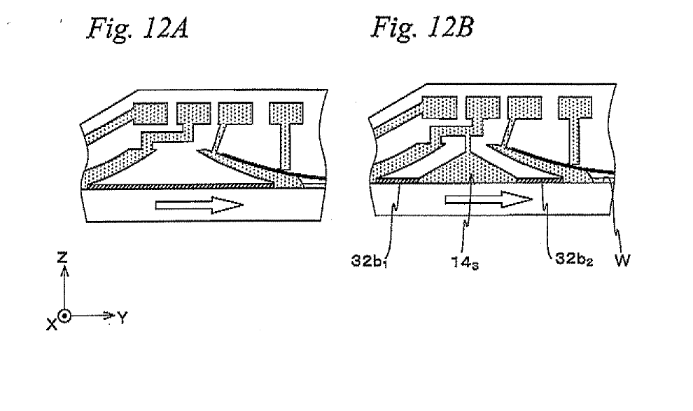

Furthermore, in the embodiment, because annular recess section 32n is formed, or in other words, buffer space 14₃ is provided, the length in the Y-axis direction of a section (the hatched section in FIG. 12B) between the first liquid immersion space 14₁ and the second liquid immersion space 14₂ of the bottom surface of nozzle member 32 which faces wafer W via a small clearance (e.g. around 0.1 [mm]) can be set shorter than the length (the hatched section in FIG. 12A) of the bottom surface of nozzle member 32 in the case shown in FIG. 12A where there is no annular recess section 32n. In other words, a viscous force and pressure force of liquid Lq in the clearance between bottom surface 32j of nozzle member 32 and wafer W, and in turn, a reaction force (a frictional force) which occurs between wafer W and liquid Lq when driving wafer W can be reduced.

Furthermore, in the embodiment, because liquid Lq in the first liquid immersion space 14₁ and liquid Lq in the second liquid immersion space 14₂ do not mix due to a function of buffer space 14₃ described above, the temperature of liquid Lq can be different inside the first liquid immersion space 14₁ and the second liquid immersion space 14₂. For example, it becomes possible to supply liquid Lq whose temperature is high into the second liquid immersion space 14₂ rather than the first liquid immersion space 14₁ so as to reduce distortion and the like of the wafer due to the heat of evaporation. This method is effective such as in the case when wet air is not supplied into space (14₂) from supply opening (slit) 33e. However, buffer space 14₂ does not necessarily have to be provided.

Incidentally, in the embodiment described above, slit (recovery opening) 33f was formed at the position on the outermost periphery of inclined surface 32c of annular recess section 32h, and on its outer side, slit (supply) 33e was formed, and wet air was supplied into space (14₂) from slit (supply) 33e which allows the space around the interface to be purged, and the excess wet air supplied was recovered from recovery opening 33f. However, as well as this, purging space (14₂) with the wet air is not essential, therefore, slit 33f and slit 33e do not necessarily have to be provided. For example, the slit provided can be slit 33e only. In this case as well, the spreading of liquid Lq within the second liquid immersion space 14₂ or the alkaline solution to the outer periphery side can be stopped naturally at a position of slit 33e. Furthermore, in the case when the spreading of liquid Lq within the second liquid immersion space 14₂ or the alkaline solution to the outer periphery side can be suppressed, both slit 33f and slit 33e do not have to be provided.

### Second Embodiment

Next, a second embodiment will be described. Herein, the same or similar reference signs are used for the components that are the same as or similar to those in the first embodiment described previously, and the description thereabout is simplified or omitted.

While the exposure apparatus of the second embodiment partly differs from the first embodiment previously described regarding the configuration of the nozzle member, configuration and the like of other parts are similar to the first previously described.

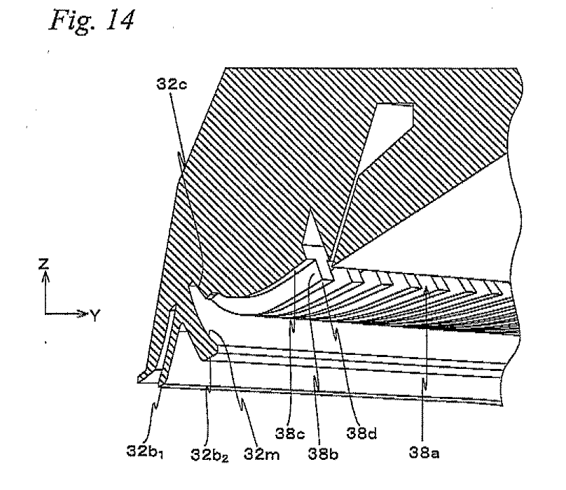

In the nozzle member of the second embodiment as well, inclined surface 32c is formed on the inner bottom surface (upper surface) facing wafer W of recess section 32h. However, in nozzle member 32′ related to the second embodiment, as shown in FIG. 14, a plurality of grooves 38a is formed on inclined surface 32c in a radial direction (radiation direction) centering on a central axis (coincides with optical axis AX) parallel to the Z-axis at a predetermined pitch (for example, two times the width of groove 38a), covering the entire circumferential direction. The width and depth of groove 38a is about the same size as the clearance between bottom surface 32j of nozzle member 32′ and wafer W, or in other words, around 0.1 mm. A liquid repellent treatment (water-repellent treatment) is applied to both the side surfaces 38b of groove 38a, a bottom surface 38c, and surfaces between adjacent grooves 38a (hereinafter described as upper surface 38d), and water-repellency with a contact angle of 90 degrees or more (e.g. 110 degrees) is given. Upper surface 38d, here, is no other than a part of inclined surface 32c.

In inclined surface 32c, supply opening 33b is formed (refer to FIG. 3) in the vicinity of the outer periphery as is previously described. Supply opening 33b, for example, consists of an opening, and a plurality of openings is provided almost equally spaced along the entire periphery of inclined surface 32c. It is desirable that supply opening 33b is provided corresponding to each groove 38a individually. Each supply opening 33b communicates with liquid supply section 36a (refer to FIG. 3).

As previously described, liquid Lq supplied obliquely from supply opening 33b from the outside toward the inside, or in other words, supplied inwardly into space (14₂), hits slope surface 32m and changes the direction of the flow along slope surface 32m, and flows into liquid recovery section 36b along the outer periphery surface (the outer wall surface) of projecting section 32b₂, via recovery opening 33c. In this case, it is desirable that liquid Lq supplied from each of the plurality of supply opening 33b flows along the inside of each groove 38a and flows into liquid recovery section 36b, via the plurality of recovery openings 33c. Thus, in the embodiment, while supply opening 33b is provided corresponding to each groove 38a individually, the present invention is not limited to this. Liquid Lq within liquid recovery section 36b is recovered by the second liquid recovery device 74₂.

The configuration of other parts of nozzle member 32′ is similar to nozzle member 32 previously described.

A principle of liquid Lq being confined inside of the second liquid immersion space 14₂ in the second embodiment will be described below, referring to FIGS. 6, and 15A to 18B.

By the liquid repellent treatment previously described, the surface of inclined surface 32c of nozzle member 32′ has contact angle β shown in FIG. 6 set, for example, to around 110 degrees or more to less than 130 degrees.

On the other hand, as for wafer W exposed by liquid immersion exposure as well, a liquid repellent coating is applied on a resist film, or a resist film is formed using a topcoatless resist having liquid repellency. Therefore, the surface of wafer W has a liquid repellency showing a contact angle (an angle α in FIG. 6) of, for example, 60 degrees or more.

As shown in FIG. 6, when liquid Lq enters the air gap between inclined surface 32c and the surface of wafer W that have liquid repellency, as is previously described, a surface tension which is strong in a direction pushing back liquid Lq acts on liquid Lq the more liquid Lq enters into the air gap between the surface of inclined surface 32 and the surface of wafer W.

Now, a necessary condition for liquid Lq to be pushed back by the surface tension, or in other words, for liquid Lq to be held to between recess section 32h and the wafer W surface (in the second liquid immersion space 14₂) is as in formula (1) previously described, in the case groove 38a is not formed on inclined surface 32c.

As previously described, in formula (1), assuming that θ=0, when α=60 degrees, then β>120 degrees.

In contrast, because many grooves 38a are formed on inclined surface 32c in the second embodiment, liquid Lq may be held between recess section 32h and the wafer W surface (in the second liquid immersion space 14₂) even in the case when the condition of formula (1) is not satisfied. In other words, assuming that θ=0, even under a condition α+β<π, liquid Lq can be held in the second liquid immersion space 142. This point will be explained further in detail.

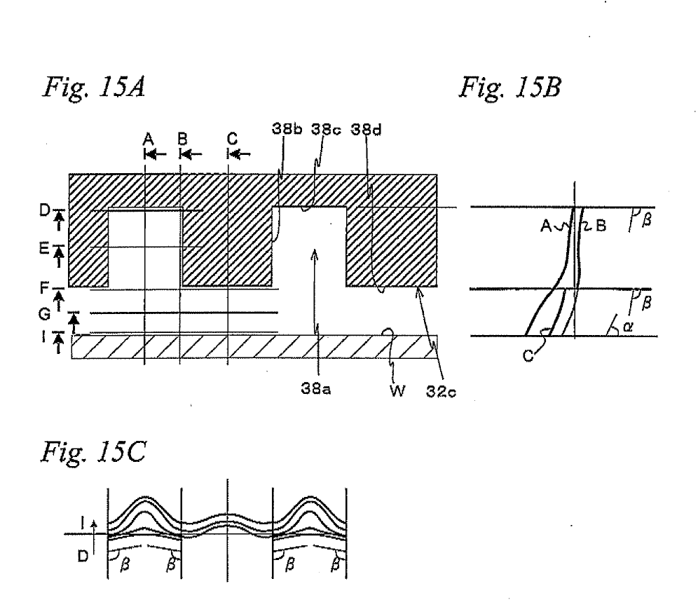

The flow around groove 38a on inclined surface 32c in the second liquid immersion space 142 in the embodiment will be typically shown, using FIGS. 15A to 15C. FIG. 15A shows a sectional view of a portion of two adjacent grooves 38a of inclined surface 32c and wafer W when viewed from an outer periphery side of nozzle member 32′. FIG. 15B schematically shows a shape curve (expected shape) of an interface at a virtual section (a surface when viewed from the arrow direction) along each of the sectional lines A, B, and C in FIG. 15A, using the same reference codes A, B, and C. Further, FIG. 15C schematically shows a shape of an interface at a virtual section (a surface when viewed from the arrow direction) along each of the sectional lines B, E, F, G, and I in FIG. 15A. Five curves (waveforms) show a shape (expected shape) of an interface at a virtual section, along sectional lines D, E, F, G, and I, sequentially from below.

When virtual section A is defined at the center (the center between the pair of opposing side surfaces 38b) of groove 38a, because a gap (clearance) opens between wafer W and inclined surface 32c at virtual section A, liquid Lq which has entered into the inside of groove 38a attempts to flow outside from groove 38a. However, because the surface tension of liquid Lq has increased according to the total area of the pair of opposing side surfaces 38b when compared with the case when there is no groove 38a, as a consequence, liquid Lq inside groove 38a is drawn into and is held in the groove by the strong surface tension acting on the pair of side surfaces 38b. At virtual section B, liquid Lq is further affected by the surface tension acting on upper surface 38d. At virtual section C, contact angle of the wafer W side is α, and contact angle of the upper surface 38d is β. From the description so far, the interfacial shape of liquid Lq flowing in groove 38a is as shown in FIG. 15B at each virtual section. When a similar study is performed for virtual sections D, E, F, G, and I, respectively, contour lines (wave type) shown in FIG. 15 (C) are obtained.

Furthermore, because a surface tension which is strong in a direction pushing back liquid Lq acts on liquid Lq when liquid Lq enters further into the air gap between the surface of inclined surface 32c and the surface of wafer W, as a whole, a surface tension which draws liquid Lq from the outer periphery side into the inner periphery side acts on liquid Lq.

Now, a sufficient condition for liquid Lq to be held between recess section 32h and the wafer W surface (inside the second liquid immersion space 14₂), or in other words, a condition (critical velocity of wafer W) for liquid Lq to be held in between recess section 32h and the wafer W surface (inside the second liquid immersion space 14₂) even if wafer w moves, will be described.

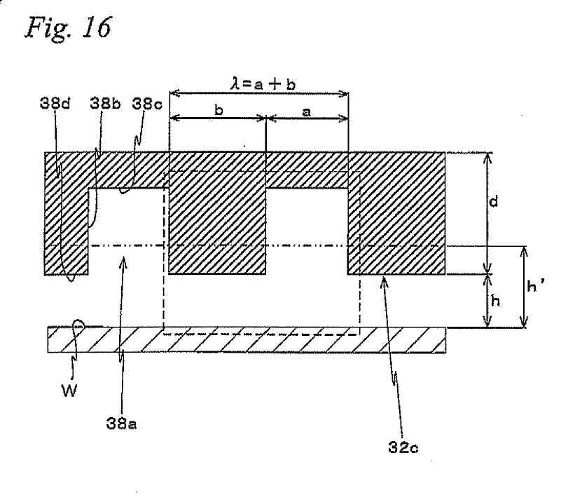

Now, to perform a computation of critical velocity of wafer W in a simple manner, θ=0 and a parallel plate flow will be applied. Because of this a flow of liquid Lq in the second liquid immersion space 14₂ is converted into an equivalent parallel plate flow. FIG. 16 shows a sectional view of a portion of two adjacent grooves 38a of inclined surface 32e and wafer W when viewed from an outer periphery side of nozzle member 32′. As shown in FIG. 16, the dimension of side surface 38b, bottom surface 38c, and upper surface 38d of groove 38a is to be d, a, b, respectively. Further, the height from the wafer W surface is to be h. And, a part surrounded by a rectangle of a broken line in FIG. 16, or in other words, a part showing one pitch (one period of a ridge and a groove) of groove 38a will be extracted and considered. In this case, when height h′ from the wafer W surface of a parallel plate surface (in other words, average wall surface) without any grooves is obtained, which is equivalent to inclined surface 32c of the embodiment on which groove 38a is formed, height h′ is as follows. In other words, height h′ of the average wall surface to be obtained, is no other than height h′ in the case the following formula (7) is valid, which is when an area of a rectangle with height h′ and width (a+b) is equal to the sum of an area of a rectangle with height h and width (a+b) and an area of a rectangle with height d and width a.

(a+b)·h′=(a+b)·h+ad (7)

By solving formula (2), h′ can be obtained as in formula (8).

h′=h+ad/(a+b) (8)

When width a of bottom surface 38c of groove 38a, height (depth of groove) d of side surface 38b, width b of upper surface 38d, and a distance (gap) h between the wafer W surface and the surface of inclined surface 32c are nondimensionalized using λ=(a+b), they can be expressed as in formulas (9) to (12) below.

$$\begin{matrix}\hat{a} = \frac{a}{a + b} & ( 9 ) \\ \hat{b} = \frac{b}{a + b} & ( 10 ) \\ \hat{d} = \frac{d}{a + b} & ( 11 ) \\ \hat{h} = \frac{h}{a + b} & ( 12 )\end{matrix}$$

Height (the position of the z-axis direction) h′ of the average wall surface from the wafer W surface is expressed as formula (13) below from formula (8).

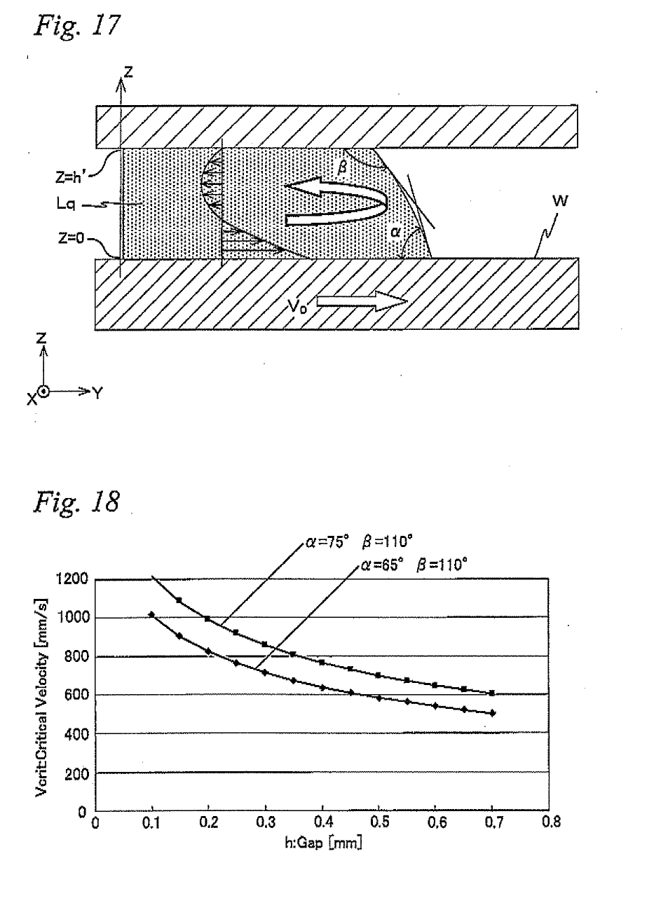

FIG. 17 shows a velocity distribution (Z=0−Z=h′) of liquid Lq in a height direction (the z-axis direction) in the case wafer W moves in the +Y direction at a velocity V₀. Velocity V at an arbitrary Z position in this case can be obtained as in formula (14) below, by solving a parallel flat plate flow when the total sum of velocity Σ Vdz with V=V₀ at a boundary condition Z=0 and also V=0 at Z=h′.

$$V = \frac{3 {V}_{0}}{{{h}^{′}}^{2}} ( Z - {h}^{′} ) ( Z - {h}^{′} / 3 ) \qquad ( 14 )$$

Momentum reaction force F_{w} of liquid Lq received at the interface can be obtained as is shown in formula (16), by performing a calculation of substituting V of formula (14) into V (Z) of formula (15) below. In formula (16), ρ is the density of liquid Lq.

$$\begin{matrix}{F}_{w} = {\int }_{0}^{{h}^{′}} ρ {V ( Z )}^{2} d Z & ( 15 ) \\ {F}_{w} = \frac{2}{15} ρ {V}_{0}^{2} {h}^{′} & ( 16 )\end{matrix}$$

The balance between momentum reaction force F_{w} and surface tension will now be considered. In the embodiment, because there are grooves, the area of the surface in contact with liquid Lq, accordingly, when thinking in cross-section, peripheral length increases (peripheral length increases by 2d per one λ) than when there is no groove. As a result, because the sum of the surface tension increases, the balance between momentum reaction force F_{w} and the surface tension is expressed as formula (17) below. In formula (17), γ is the surface tension of liquid Lq.

F_{w}=−γ{cos α+(1+2\hat{d})cos β} (17)

When the formulas above are solved, critical velocity V_{crit} it expressed as in formula (18) below is obtained.

$$Vcrit = \sqrt{\frac{- 15 γ ( cos α + ( 1 + 2 \hat{d} ) cos β )}{2 ρ ( h + \hat{a} \hat{d} λ )}} \qquad ( 18 )$$

To increase critical velocity V_{crit} from formula (18) above, it can be seen that it is effective to reduce pitch λ of groove 38a, and to also reduce width a (width a of bottom surface 38c) of groove 38a. However, when width a becomes too small, liquid Lq does not enter groove 38a due to the viscosity of liquid Lq and the liquid repellency of side surface 38b, therefore, the increasing effect (increase of the sum of the surface tension due to the increase of the peripheral length by 2d per one λ) of the surface tension which was obtained by providing grooves cannot be obtained. In order to prevent such a situation from occurring, in the embodiment, by separately and individually providing supply opening 33b of the liquid to the second liquid immersion space 14₂ in the bottom surface 38c of groove 38 and supplying liquid Lq along groove 38a, liquid Lq is filled in the groove, which secures the increasing effect of the surface tension obtained by providing groove 38a.

FIG. 18 shows an example of results when obtaining critical velocity V_{crit} [mm/s] in the range of gap h=0.1-0.7 [mm] when a=0.15, b=0.15, λ=0.3, and d=0.2 (unit is [mm]). As it can also be seen from FIG. 18, if a plurality of grooves 38 is provided and gap h is set to 0.2 [mm] or less, by only applying a high water repellent coating with a contact angle of around 110 degrees which falls short of a super water repellency to inclined surface 32c, it can be seen that tolerance of high scanning can be achieved even if the angle of inclination of inclined surface 32c is zero, or θ=0. However, because θ>0, in the case of the embodiment, the contact angle of inclined surface 32c can be 110 degrees or less, and for example, by setting angle of inclination θ appropriately taking into consideration contact angle α of the wafer surface, contact angle β of around 90 degrees or more is enough. In the case of the embodiment, when the contact angle of inclined surface 32c is 110 degrees or more, liquid Lq can be held securely between recess section 32h and the wafer W surface (within the second liquid immersion space 14₂).

As is described above, according to the exposure apparatus of the second embodiment, an equivalent effect can be obtained as in the first embodiment previously described. In addition, in the second embodiment, many grooves 38a are formed on inclined surface 32c on the inner bottom surface (upper surface) of recess section 32h facing wafer w provided in nozzle member 32′. Accordingly, in the exposure apparatus of the second embodiment, liquid Lq can be held between recess section 32h and the wafer W surface in the second liquid immersion space 14₂) without fail, even if the contact angle of the inner bottom surface (including inclined surface 32c) of recess section 32h of nozzle member 32′ is less than 110 degrees, and the inner bottom surface (including inclined surface 32c) of recess section 32h does not have to be super water-repellent with a contact angle of 150 degrees or more. Further, if the contact angle of the inner bottom surface of recess section 32h of nozzle member 32′ is about the same level as nozzle member 32, liquid Lq can be held in the second liquid immersion space 14₂ more securely.

Incidentally, in the embodiment above, while the case has been described where an annular inclined surface 32c was formed on the inner bottom surface of annular recess section 32h facing wafer W of nozzle member 32′, and on inclined surface 32c, a plurality of grooves 38a was formed at a predetermined pitch covering the entire circumferential direction, an inclined surface does not have to be formed on the inner bottom surface of annular recess section 32h, and only forming many grooves is also acceptable.

### Third Embodiment

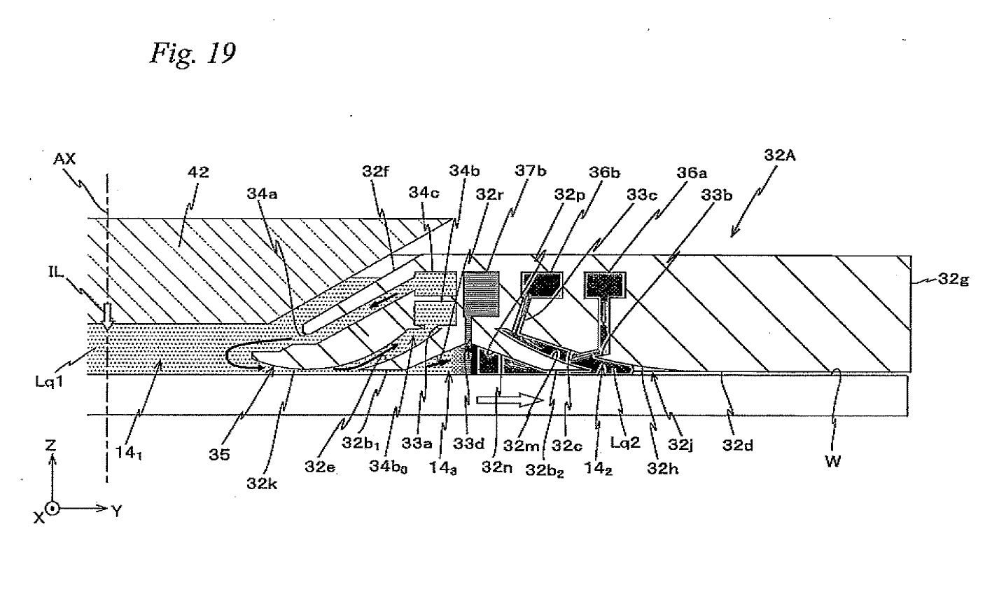

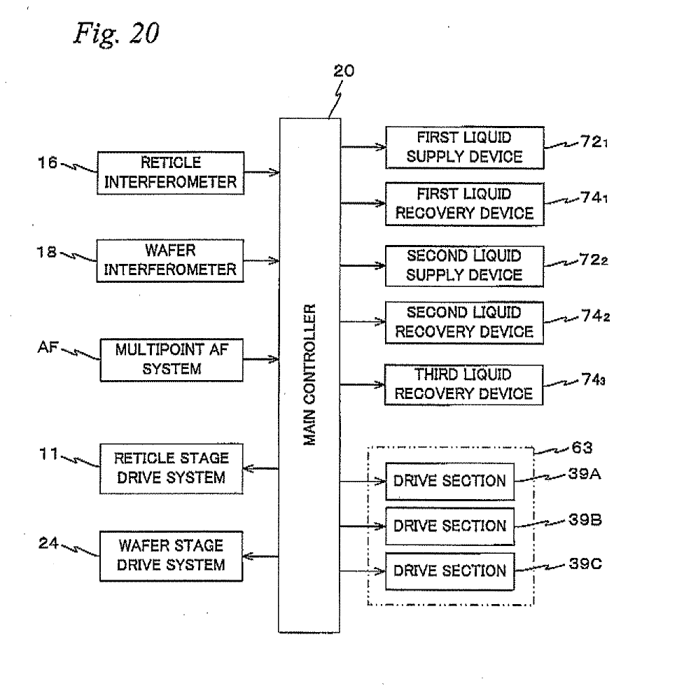

Next, a third embodiment will be described, with reference to FIGS. 19 and 20. Herein, the same or similar reference signs are used for the components that are the same as or similar to those in the first and second embodiments described previously, and the description thereabout is simplified or omitted.

FIG. 19 shows a longitudinal sectional view of the +Y side half of a nozzle member 32A equipped in an exposure apparatus of the third embodiment, with the −Y side half omitted. The reason why the −Y side half was omitted is because nozzle member 32A has a shape which is rotationally symmetric around an axis (coincides with optical axis AX in the embodiment) parallel to the Z-axis. Further, FIG. 20 is a block diagram that shows an input/output relation of a main controller which is equipped in the exposure apparatus of the third embodiment.

The exposure apparatus of the third embodiment differs from the exposure apparatus of the first embodiment previously described on the following points: A liquid Lq1 is supplied into a space (14₁) including the optical path of illumination light IL enclosed by tip lens 42 and wafer W from the first liquid supply device 72₁ and a liquid Lq2 is supplied into a space (14₂) from the second liquid supply device 72₂, a third liquid recovery device 74₂ is provided (refer to FIG. 20) as the liquid recovery device, in addition to the first and second liquid recovery devices 74₁ and 74₂, and a part of the configuration of the nozzle member differs from the exposure apparatus of the first embodiment. Other sections are configured similar to those of the exposure apparatus of the first embodiment described earlier. The third embodiment will be described below, focusing mainly on the difference.

In the embodiment, as liquid Lq1, a high refractive index liquid having a refractive index which is higher than pure water (having a refractive index with respect to a light of 193.3[nm] which is around 1.44) and also lower than tip lens 42 (refer to FIG. 19) is used. In the case the material of tip lens 42 is a synthetic quarts glass (refractive index to light of 193.3[nm] is 1.56), for example, isopropanol whose refractive index is around 1.50 can be used as liquid Lq1. Further, for example, also in the case the material of tip lens 42 is a single crystal material of a fluoride compound such as calcium fluoride (fluorite), barium fluoride, strontium fluoride, lithium fluoride, and sodium fluoride, a high refractive index liquid having a refractive index of about 1.50 can be used as liquid Lq1.

Further, for example, tip lens 42 can be formed of a material having a refractive index which is higher than quartz or fluorite (e.g. 1.6 or more). As the materials having a refractive index equal to or higher than 1.6, for example, sapphire, germanium dioxide, or the like disclosed in the pamphlet of International Publication No. 2005/059617, or kalium chloride (having a refractive index of about 1.75) or the like disclosed in the pamphlet of International Publication No. 2005/059618 can be used. In this case, for example, a predetermined liquid having a C—H binding or an O—H binding such as glycerol (glycerin) having a refractive index of about 1.61, a predetermined liquid (an organic solvent) such as hexane, heptane, or decalin (Decalin: Decahydronaphthalene) having a refractive index of 1.60, or a liquid obtained by mixing arbitrary two or more of these liquids, or a liquid obtained by adding (mixing) at least one of these liquids to (with) pure water can be used as liquid L1. Further, it is preferable that liquid Lq1 is a liquid which has a small absorption coefficient of light, is less temperature-dependent, and is stable to a photosensitive agent (or a protection film (top coat film), an antireflection film, or the like) coated on a projection optical system (tip optical member) and/or the surface of a wafer.

Further, in the embodiment, water is used as liquid Lq2. However, liquid Lq2 is not limited to water, and other liquid having a refractive index which is the same level as water can be used as well.

As is obvious when comparing FIGS. 19 and 3, nozzle member 32A related to the embodiment is basically configured similar to nozzle member 32 previously described. However, the shape and the like of the inner side projection and the outer periphery of bottom surface 32j of nozzle member 32A are different from nozzle member 32.

As shown in FIG. 19 lower surface 32k of inner side projection 35 has a shape which gradually nears wafer W from the inner periphery to the outer periphery and after reaching a predetermined position, gradually moves away (rises upward) from wafer or to be more specific, an arc shape whose cross section is a downward convex. The distance between lower surface 32k of inner side projection 35 and wafer W is about the same level as the distance (e.g., 0.1 [mm]) between bottom surface 32j (the lower surface of projecting sections 32b₁, 32b₂ and 32d) and wafer W at the smallest point.

Further, nozzle member 32A is different from nozzle member 32 previously described, and the slit previously described is not formed on bottom surface 32j, and the outer periphery section of bottom surface 32j is orthogonal to outer periphery surface 32g consisting of a cylindrical surface (a surface parallel to optical axis AX along the entire periphery) whose central axis is optical axis AX. However, such an arrangement does not always have to be employed, and for example, the outer periphery of the bottom surface can have a surface with an arc-shaped cross section formed along the entire periphery, or the outer periphery surface can be a tapered surface (a conical surface) whose upper end is tilted inward, and its surface can be hydrophilic.

In the embodiment, corresponding to the point that liquids Lq1, and Lq2 which are different are used, the first liquid supply device 72₁ and the second liquid supply device 72₂ are provided independent from each other. Further, the temperature of Lq1 supplied from the first liquid supply device 72₁ to nozzle member 32A and the temperature of liquid Lq2 supplied from the second liquid supply device 72₂ to nozzle member 32A are adjusted (temperature control) independently. Generally, while the precision of the temperature control has to be higher than water with high refractive index liquid because high refractive index liquid has a larger refractive index change to temperature change than water, in the embodiment, the temperature of each of the liquids can be controlled appropriately according to the temperature control precision required by liquids Lq1 and Lq2 in the embodiment.

Further, as shown in FIG. 19, at the position (a position at the top of the chevron) on the upper end (the +Z side) of annular recess section 32n of nozzle member 32A, a plurality of recovery openings 33d consisting of an opening provided almost equally along the entire periphery communicates with liquid recovery section 37b. Liquid recovery section 37b is formed inside of nozzle member 32A, and includes at least a liquid recovery flow channel including a ring shaped flow channel to which a plurality of recovery openings 33d is connected, and the liquid recovery flow channel is connected to a third liquid recovery device 74₃ provided separately from the first liquid recovery device 74₁ and the second liquid recovery device 74₂, via one or more recovery pipes (not shown), a valve (not shown) and the like. Incidentally, recovery opening 33d can be configured of a ring shaped groove section formed along the entire periphery. In this case, the ring shaped flow channel configuring a part of liquid recovery section 37b can be configured by the ring shaped groove section.

The third liquid recovery device 74₃, for example, is equipped with a vacuum system (suction device) such as a vacuum pump, a gas-liquid separator which separates liquids Lq1 and Lq2 that have been recovered and gas, a tank which houses the liquids that have been recovered and the like. Incidentally, as the vacuum system, at least one of a vacuum system such as the vacuum pump, the gas-liquid separator, and the tank can be substituted with the facilities of the factory where the exposure apparatus is installed, without the parts being provided in the exposure apparatus.

In the embodiment, liquid recovery opening 34b typically shown in FIG. 19 communicates with recovery opening 33a. And liquid recovery section 34b is connected to the first liquid recovery device 74₁. Alternatively, for example, recovery opening 33d can communicate with liquid recovery section 34b or liquid recovery section 36b instead of liquid recovery section 37b, and can be connected to the first liquid recovery device 74₁ or the second liquid recovery device 74₂. In this case, the third liquid recovery device 74₃ does not have to be provided.

In the embodiment, when liquid Lq1 is supplied to nozzle member 32A from the first liquid supply device 72₁ (refer to FIG. 20), liquid Lq1 is supplied into a space (14₁) including the optical path of illumination IL enclosed by tip lens 42 and wafer W in a laminar flow state along an arrow shown in FIG. 19, from supply opening 34a via liquid supply section 34c, via a gap between inner side projection 35 of nozzle member 32A and the lower surface of tip lens 42. This allows space (14₁) to be filled with plenty of liquid Lq1 whose temperature is controlled with high precision, and a first liquid immersion space (hereinafter, also appropriately describe 14₁ as a liquid immersion space) 14₁ having a uniform temperature distribution 14₁ is formed.

And this Liquid Lq1 flows through the inside of liquid recovery path 34b₀, and is collected by first liquid recovery device 74₁ via liquid recovery section 34b.

Further, in the case wafer W moves in the −Y direction in FIG. 19, liquid (a mixture of liquid Lq1 and liquid Lq2) filled in buffer space 14₃ moves in the −Y direction (a flow is generated in the −Y direction) along with the movement of wafer W due to viscosity of the liquid. However, the amount of liquid (a mixture of liquid Lq1 and liquid Lq2) leaking out into liquid immersion space 14₁ (space at the exposure area side of projecting section 32b₁) passing through the small gap (e.g. around 0.1 mm) between the lower surface of projecting section 32b1 and wafer W. Further, because lower surface 32k of inner side projection 35 has an arc shape whose cross section is a downward curve, when a flow of liquid Lq1 supplied from supply opening 34a flows from the inside toward the outside (when the liquid flows between lower surface 32k and wafer W), liquid Lq1 which has been accelerated by the narrowing flow path will pass through a diffuser passage having a widening flow path toward the outer side. Because pressure increases in this diffuser passage, the liquid (mixture of liquid Lq1 and liquid Lq2) which has leaked out slightly into immersion space 14₁ (space at the exposure area side of projecting section 32b₁) passing through the gap cannot act against the pressure and will not flow into the exposure area. Accordingly, liquid (mixture of liquid Lq1 and liquid Lq2) which has leaked out slightly into immersion space 14₁ (space at the exposure area side of projecting section 32b₁) flows along the flow shown by the arrow in FIG. 19 inside liquid recovery path 34b₀ (guided by the lower side guide surface 32e), and flows into liquid recovery section 34b. The liquid inside liquid recovery section 34b is recovered by the first liquid recovery device 74₁.

When liquid Lq2 is supplied from the second liquid supply device 72₂, liquid Lq2 passes through liquid supply section 36a, and is supplied along the arrow shown in FIG. 19 and inwardly into space (14₂) from supply opening 33b. This allows space (14₂) to be filled with liquid Lq2, and a second liquid immersion space (an auxiliary liquid immersion space) 14₂ is formed.

Recovery opening 33c is located at the inner periphery of recess section 32h, or namely, the upper end of the outer periphery surface of projecting section 32b₂. Further, as is previously described, liquid Lq2, which is obliquely supplied from supply opening 33b from the outside toward the inside, hits slope surface 32m without fail. Accordingly, liquid Lq2 which is supplied inwardly into space (14₂) changes the direction of the flow according to the arrow shown in FIG. 19, and flows into liquid recovery section 36b along an outer periphery surface (an outer wall surface) of projecting section 32b₂, via recovery opening 33c. Liquid Lq2 within liquid recovery section 36b is recovered by the second liquid recovery device 74₂.

Further, even if liquid Lq2 including particles and/or air bubbles and the like enters buffer space 14₃ from the auxiliary liquid immersion space 14₂, particles and/or air bubbles are collected by the third liquid recovery device 74₃ along with liquid Lq2 passing through recovery opening 33d via liquid recovery section 37b. Liquid Lq1 which has leaked into buffer space 14₃ from liquid immersion space 14₁ is also recovered by the third liquid recovery device 74₃.

According to the exposure apparatus of the third embodiment which is configured in the manner described above, an equivalent effect can be obtained as in the exposure apparatus of the first embodiment previously described. In addition, liquid Lq1 having a higher refractive index than water is supplied to the inside of nozzle member 32A from the first liquid supply device 72₁ via supply opening 34a, and liquid immersion space 14₁ is formed between tip lens 42 and wafer W, and liquid Lq1 inside of liquid immersion space 14₁ is recovered by the first liquid recovery device 74₁ via recovery opening 33a and liquid recovery section 34b. At this point, main controller 20 controls the first liquid supply device 72₁ and the first liquid recovery device 74₁, and this allows liquid Lq1 (constantly replaced) of a fixed quantity to be constantly held inside liquid immersion space 14₁. And, the plurality of shot areas on wafer W is exposed with illumination light IL (an image light flux of a pattern of reticle R) via tip lens 42 and liquid Lq inside of liquid immersion space 14₁. This allows an image of the pattern of reticle R to be transferred with a resolution much higher than when using water as the liquid for liquid immersion on the plurality of shot areas on wafer W. Further, because lower surface 32k of inner side projection 35 has an arc shape in a downward convex, this can prevent an inflow of liquid Lq2 from the outer periphery (within auxiliary liquid immersion space 14₂, and buffer space 14₃) to the exposure area.

### Modified Example

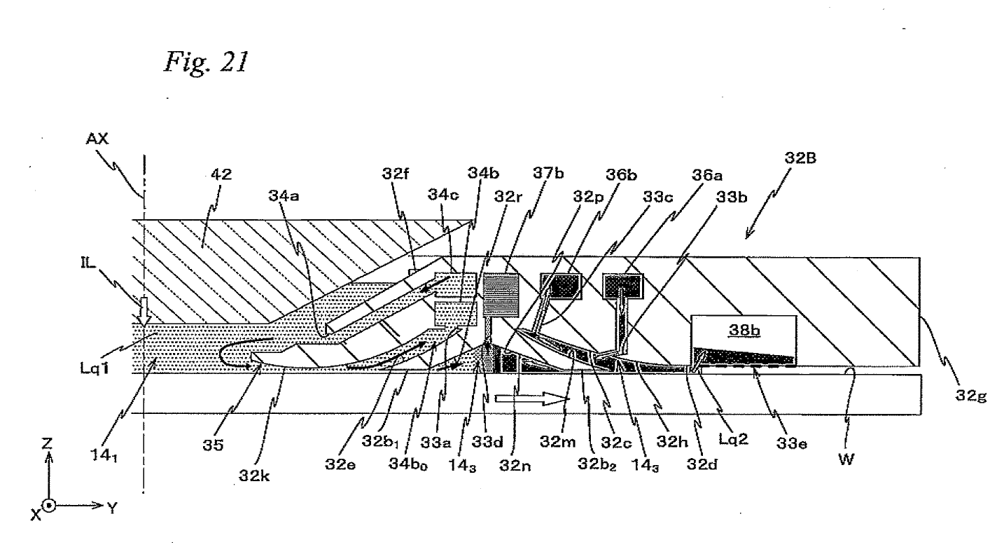

FIG. 21 shows a longitudinal sectional view of the +Y side half of a nozzle member 32B related to a modified example of the exposure apparatus of the third embodiment, with the −Y side half omitted. The reason why the −Y side half was omitted is because nozzle member 32B has a shape which is rotationally symmetric around an axis (coincides with optical axis AX in the embodiment) parallel to the Z-axis.

As is obvious when comparing FIGS. 21 and 19, nozzle member 32B is basically configured similar to nozzle member 32A previously described, but differs on the following points. In other words, nozzle member 323 has a recovery opening 33g in the outer periphery section of inclined surface 32c. Recovery opening 33g is provided above wafer W so that the opening faces wafer W, and recovery opening 33g and wafer W is set apart only by a predetermined distance (e.g. around 0.2 [mm]). Recovery opening 33g is formed on the outer side of supply opening 33b, in an annular shape surrounding supply opening 33b. Recovery opening 33g communicates with liquid recovery section 38b typically shown in FIG. 21. Liquid recovery section 38b is formed inside of nozzle member 32B, and includes at least a liquid recovery flow channel including a ring shaped flow channel to which recovery opening 33g is connected, and the liquid recovery flow channel is connected to a fourth liquid recovery device (not shown), via one or more recovery pipes not shown), a valve (not shown) and the like. Incidentally, recovery opening 33g can be a plurality of recovery openings which are placed almost equally spaced along the entire periphery.

Recovery opening 33g, as disclosed in, for example, U.S. Patent Application Publication No. 2008/0266533, has a porous member made of stainless steel (e.g. SUS316) that has a plurality of holes formed. Incidentally, the porous member may be arranged in a plurality of number overlapping one another.

According to nozzle member 323 related to the modified example, because recovery of the liquid (including residual liquid) via recovery opening 33g also becomes possible, the liquid and air bubbles and particles in the liquid that remain on the wafer can be securely reduced further when compared with the third embodiment described above.

Incidentally, in the first and second embodiments described above, while the same liquid, or in other words, water was supplied to the first liquid immersion space 14₁ and the second liquid immersion space 14₂, besides this, a different liquid can be supplied to the inside of the first liquid immersion space 14₁ and the second liquid immersion space 14₂ as in the third embodiment. In this case, when water is supplied into the first liquid immersion space 14₁, a liquid having a refractive index smaller than water can be supplied into the second liquid immersion space 14₂.

Incidentally, in each of the first to third embodiments and the modified example described above (hereinafter shortly described as each embodiment), while examples were given where nozzle members 32, 32′, 32A, and 32B have an annular shape which surrounds the optical path of illumination light IL, and annular recess sections 32n and 32h are formed on bottom surface 32j to which wafer W is placed facing, the present invention is not limited to this. For example, in all of the cases, annular recess section 32n to form buffer space 14₅ in the nozzle member and/or slope surface 32m does not necessarily have to be formed. Further, in the second and the third embodiments, at least one of slit 33e, slit 33f, and the wet air supply section similar to the first embodiment can be provided. Further, in the first and second embodiments, recovery opening 33g can be provided as in the modified example previously described. As described, each embodiment above can be optionally combined with one another.

Further, the recess section formed on the bottom surface of the nozzle member is not limited to an annular shape, and the recess section can be an annular shape with one portion missing such as a C shape or a rectangular shape lacking the four corners, or other shapes as long as the recess section is located on the outer periphery of the optical path of illumination light IL. If the nozzle member can be placed at an outer periphery side of the optical path of illumination light IL, the nozzle member does not necessarily have to have an annular shape. Further, it is a matter of course that the combination of the components shown in FIG. 5 previously described is a mere example.

Incidentally, in each embodiment described above, while the case has been described where the whole nozzle member 32 which is formed integrally is driven finely in the Z-axis direction by nozzle drive device 63, the present invention is not limited to this, and in the case nozzle member 32 is configured of a plurality of components, a plurality of components that face the surface of wafer W via a predetermined clearance (e.g. around 0.1 [mm]) can be made to be finely driven in the axial direction integrally or individually.

Incidentally, in each embodiment described above, the position of wafer stage WST was measured using wafer interferometer 18. Now, instead of wafer interferometer 18, an encoder (an encoder system configured of a plurality of encoders) can also be used. Or, wafer interferometer 18 and an encoder can be used together. In such a case, as the encoder (encoder head), a one-dimensional head whose measurement direction is only in one direction within the XY plane, a two-dimensional head whose measurement direction is in two direction orthogonal to each in the XY plane, and a head whose measurement direction is in two directions which are one direction in the XY plane and the Z axis direction and the like can be used. Further, it is possible to provide the encoder (encoder head) outside of the wafer stage and a scale on the wafer stage, or on the contrary, it is possible to provide the encoder (encoder head) on the wafer stage and the scale outside of the wafer stage.

Incidentally, in each embodiment described above, while the case has been described where the exposure apparatus is a scanning stepper, the present invention is not limited to this, and can also be a static exposure apparatus such as a stepper. Further, each of the embodiments above can also be applied to a reduced projection exposure apparatus by a step-and-stitch method that synthesizes a shot area and a shot area.

Further, each of the embodiments above can also be applied to a reduced projection exposure apparatus by a step-and-stitch method that synthesizes a shot area and a shot area.

In addition, the illumination light IL is not limited to ArF excimer laser light (with a wavelength of 193[mm]), but may be ultraviolet light, such as KrF excimer laser light (with a wavelength of 248 [nm]), or vacuum ultraviolet light, such as F₂ laser light (with a wavelength of 157[nm]). As disclosed in, for example, U.S. Pat. No. 7,023,610, a harmonic wave, which is obtained by amplifying a single-wavelength laser beam in the infrared or visible range emitted by a DFB semiconductor laser or fiber laser as vacuum ultraviolet light, with a fiber amplifier doped with, for example, erbium (or both erbium and ytterbium), and by converting the wavelength into ultraviolet light using a nonlinear optical crystal, can also be used.

Moreover, the present invention can also be applied to a multi-stage type exposure apparatus equipped with a plurality of wafer stages, as is disclosed in, for example, U.S. Pat. No. 6,590,634, U.S. Pat. No. 5,969,441, U.S. Pat. No. 6,208,407 and the like. Further, each of the embodiments described above can also be applied to an exposure apparatus equipped with a measurement stage including a measurement member (for example, a reference mark, and/or a sensor and the like) different from the wafer stage, as disclosed in, for example, International Publication No. 2005/074014.

Further, in the embodiment above, a light transmissive type mask (reticle) is used, which is obtained by forming a predetermined light-shielding pattern (or a phase pattern or a light-attenuation pattern) on a light-transmitting substrate, but instead of this reticle, as disclosed in, for example, U.S. Pat. No. 6,778,257, an electron mask (which is also called a variable shaped mask, an active mask or an image generator, and includes, for example, a DMD (Digital Micromirror Device) that is a type of a non-emission type image display element (spatial light modulator) or the like) on which a light-transmitting pattern, a reflection pattern, or an emission pattern is formed according to electronic data of the pattern that is to be exposed can also be used. In the case of using such a variable shaped mask, because the stage where a wafer, a glass plate or the like is mounted is scanned with respect to the variable shaped mask, an equivalent effect as the embodiment above can be obtained by measuring the position of this stage using an encoder system and a laser interferometer system.

Further, as disclosed in, for example, PCT International Publication No. 2001/035168, each of the embodiments above can also be applied to an exposure apparatus (a lithography system) in which line-and-space patterns are formed on wafer W by forming interference fringes on wafer W.

Moreover, each of the embodiments above can also be applied to an exposure apparatus that synthesizes two reticle patterns on a wafer via a projection optical system and substantially simultaneously performs double exposure of one shot area on the wafer by one scanning exposure, as disclosed in, for example, U.S. Pat. No. 6,611,316.

Incidentally, an object on which a pattern is to be formed (an object subject to exposure on which an energy beam is irradiated) in each embodiment above and the like is not limited to a wafer, but may be another object such as a glass plate, a ceramic substrate, a film member, or a mask blank.

The usage of the exposure apparatus is not limited to the exposure apparatus used for manufacturing semiconductor devices, but the present invention can be widely applied also to, for example, an exposure apparatus for manufacturing liquid crystal display elements in which a liquid crystal display element pattern is transferred onto a rectangular glass plate, and to an exposure apparatus for manufacturing organic EL, thin-film magnetic heads, imaging devices (such as CCDs), micromachines, DNA chips or the like. Further, each of the embodiments above can also be applied to an exposure apparatus that transfers a circuit pattern onto a glass substrate, a silicon wafer or the like not only when producing microdevices such as semiconductor devices, but also when producing a reticle or a mask used in an exposure apparatus such as an optical exposure apparatus, an EUV exposure apparatus, an X-ray exposure apparatus, and an electron beam exposure apparatus.

Electronic devices such as semiconductor devices are manufactured through the steps of a step where the function/performance design of the device is performed, a step where a reticle based on the design step is manufactured, a step where a wafer is manufactured from silicon materials, a lithography step where the pattern of a mask (the reticle) is transferred onto the wafer by the exposure apparatus (pattern formation apparatus) and the exposure method in each of the embodiments previously described, a development step where the wafer that has been exposed is developed, an etching step where an exposed member of an area other than the area where the resist remains is removed by etching, a resist removing step where the resist that is no longer necessary when etching has been completed is removed, a device assembly step (including a dicing process, a bonding process, the package process), inspection steps and the like. In this case, in the lithography step, because the device pattern is formed on the wafer by executing the exposure method previously described by the exposure apparatus in each embodiment above, a highly integrated device can be produced with good productivity.

Incidentally, the disclosures of all publications, the Published PCT International Publications, the U.S. patent applications and the U.S. patents that are cited in the description so far related to exposure apparatuses and the like are each incorporated herein by reference.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. An exposure apparatus that exposes an object with an energy beam via an optical member and a liquid, the apparatus comprising:
a liquid immersion member which is placed facing the object on an outer periphery side of a beam path of the energy beam, and on a first surface to which the object is placed opposing, a first recess section to form an auxiliary liquid immersion space between the object and the liquid immersion member is formed; and
a first liquid supply system which supplies the liquid inside the liquid immersion member to form a liquid immersion space between the optical member and the object.

2. The exposure apparatus according to claim 1 wherein
on the first surface of the liquid immersion member, double projecting sections are formed on the inner side and the outer side of the first recess section.

3. The exposure apparatus according to claim 1 wherein
in the inner bottom surface of the first recess section of the liquid immersion member, an inclined surface whose distance with the object surface becomes smaller from the inner side to the outer side is formed.

4. The exposure apparatus according to claim 3 wherein
the inclined surface has liquid repellency with a contact angle equal to or larger than 90 degrees.

5. The exposure apparatus according to claim 4 wherein
the inclined surface has liquid repellency with a contact angle equal to or larger than 130 degrees.

6. The exposure apparatus according to claim 4 wherein
the inclined surface has super liquid repellency with a contact angle equal to or larger than 150 degrees.

7. The exposure apparatus according to claim 3, the apparatus further comprising:
a second liquid supply system which supplies one of a same liquid as the liquid and a different liquid to the auxiliary liquid immersion space from the outside toward the inside.

8. The exposure apparatus according to claim 7 wherein
the second liquid supply system includes
a liquid supply device which supplies liquid to the auxiliary liquid immersion space from the outer side toward the inner side via a supply opening provided on the inclined surface, and
a liquid recovery device which recovers liquid inside the auxiliary liquid immersion space via a recovery opening located near the upper end of the inclined surface.

9. The exposure apparatus according to claim 8 wherein
in the first recess section of the liquid immersion member, a guide surface of liquid supplied to the auxiliary liquid immersion space is formed, facing the supply opening.

10. The exposure apparatus according to claim 9 wherein
the guide face includes a slope surface which faces a part of the inclined surface and rises upward to the inside from the first surface.

11. The exposure apparatus according to claim 8 wherein
recovery of the liquid from the auxiliary liquid immersion space is performed in a state without the liquid being in contact with gas.

12. The exposure apparatus according to claim 8 wherein
supply of the liquid to the auxiliary liquid immersion space is performed in a state without the liquid being in contact with gas.

13. The exposure apparatus according to claim 7 wherein
temperature of liquid supplied to the liquid immersion space by the first liquid supply system and liquid supplied to the auxiliary liquid immersion space by the second liquid supply system is controlled separately.

14. The exposure apparatus according to claim 7 wherein
inside of the auxiliary liquid immersion space, a flow of the liquid is formed which suppresses the liquid that has flown in from leaking to the outside passing through a gap between the liquid immersion member and the object.

15. The exposure apparatus according to claim 3 wherein
in the liquid immersion member, a slit inclined to the first surface is formed on an edge on an outer side of the inclined surface.

16. The exposure apparatus according to claim 15 wherein
the slit is inclined downward from the outer side to the inner side, and the apparatus further comprises:
a purge gas supply system which supplies a purge gas with high humidity between the first recess section and the object via the slit.

17. The exposure apparatus according to claim 16 wherein
a recovery opening of the purge gas is formed at a position on the inner side of the slit on the inclined surface of the liquid immersion member.

18. The exposure apparatus according to claim 15, the apparatus further comprising:
a cleaning liquid supply system which supplies a cleaning liquid to the auxiliary liquid immersion space.

19. The exposure apparatus according to claim 18 wherein
the cleaning liquid is an alkaline solution.

20. The exposure apparatus according to claim 18 wherein
as the object, a wafer to which an HMDS treatment has been applied is used.

21. The exposure apparatus according to claim 1 wherein
the first liquid supply system supplies the liquid to the inside of a space formed in the center of the liquid immersion member.

22. The exposure apparatus according to claim 1 wherein
in the inner bottom surface of the first recess section of the liquid immersion member, grooves having a predetermined depth and a predetermined width are formed at a predetermined pitch.

23. The exposure apparatus according to claim 22 wherein
in the inner bottom surface of the first recess section of the liquid immersion member, an inclined surface whose distance with the object surface becomes smaller from the inner side to the outer side is formed.

24. The exposure apparatus according to claim 23 wherein
the inclined surface has liquid repellency with a contact angle equal to or larger than 90 degrees.

25. The exposure apparatus according to claim 22 wherein
the inner bottom section of the first recess section has liquid repellency with a contact angle equal to or larger than 110 degrees.

26. The exposure apparatus according to claim 22 wherein
the depth and the width of the grooves have a dimension around the same level as a gap between the first surface and the object surface.

27. The exposure apparatus according to claim 1 wherein
the first liquid supply system supplies a first liquid whose refractive index is one of equal to and less than a refractive index of an optical member located at the tip of the object side, into a space between the liquid immersion member, the optical member, and the object, and the apparatus further comprises:
a second liquid supply system which supplies a second liquid having a refractive index smaller than the first liquid and at the same level as water into the auxiliary liquid immersion space.

28. The exposure apparatus according to claim 27 wherein
the first liquid is a high refractive index liquid whose refractive index is equal to 1.50 or larger.

29. The exposure apparatus according to claim 28 wherein
the first liquid is a high refractive index liquid whose refractive index is around 1.60.

30. The exposure apparatus according to claim 27 wherein
in the inner bottom surface of the first recess section of the liquid immersion member, an inclined surface whose distance with the object surface becomes smaller from the inner side to the outer side is formed.

31. The exposure apparatus according to claim 30 wherein
the second liquid supply system supplies the second liquid to the auxiliary liquid immersion space, from the outer side toward the inner side.

32. The exposure apparatus according to claim 30 wherein
the inclined surface has liquid repellency with a contact angle equal to or larger than 130 degrees.

33. The exposure apparatus according to claim 32 wherein
the inclined surface has super liquid repellency with a contact angle equal to or larger than 150 degrees.

34. The exposure apparatus according to claim 30 wherein
the second liquid supply system includes
a liquid supply device which supplies liquid to the auxiliary liquid immersion space from the outer side toward the inner side via a supply opening provided on the inclined surface, and
a liquid recovery device which recovers liquid inside the auxiliary liquid immersion space via a recovery opening located near the upper end of the inclined surface.

35. The exposure apparatus according to claim 34 wherein
in the first recess section of the liquid immersion member, a guide surface of liquid supplied to the auxiliary liquid immersion space is formed, facing the supply opening.

36. The exposure apparatus according to claim 35 wherein
the guide surface includes a slope surface which faces apart of the inclined surface and rises upward to the inside from the first surface.

37. The exposure apparatus according to claim 34 wherein
recovery of liquid from the auxiliary liquid immersion space and liquid supply to the auxiliary liquid immersion space by the second liquid supply system are performed in a state without the liquid being in contact with gas.

38. The exposure apparatus according to claim 37 wherein
temperature of the first liquid supplied to the liquid immersion space by the first liquid supply system and the second liquid supplied to the auxiliary liquid immersion space by the second liquid supply system is controlled separately.

39. The exposure apparatus according to claim 1 wherein
on the first surface of the liquid immersion member, on the inner side of the first recess section formed on the first surface, a second recess section to form a buffer space between the object and the liquid immersion member is formed.

40. The exposure apparatus according to claim 39 wherein
on a side facing the beam path of the liquid immersion member, an inner side projecting section which faces a part of a periphery of an outgoing surface of the optical member is provided.

41. The exposure apparatus according to claim 40 wherein
between the inner side projecting section and an inner side wall section of the second recess section, a recovery path of liquid is formed.

42. The exposure apparatus according to claim 41 wherein
in the second recess section of the liquid immersion member, a recovery opening to collect liquid from within a buffer space formed between the second recess section and the object is formed.

43. The exposure apparatus according to claim 42 wherein
the recovery opening is connected to a recovery section communicating with the recovery path.

44. The exposure apparatus according to claim 1 wherein
on a side facing the beam path of the liquid immersion member, an inner side projecting section which faces a part of a periphery of an outgoing surface of the optical member is provided.

45. The exposure apparatus according to claim 44 wherein
a distance of the inner side projecting section with the object surface is larger than a distance of the first surface with the object.

46. The exposure apparatus according to claim 44 wherein
a surface on the side of the inner side projecting section facing the object has a shape whose distance with the object surface from the inner side to the outer side gradually becomes large, after gradually becoming small.

47. The exposure apparatus according to claim 46 wherein
the surface of inner side projecting section is a surface whose cross section is an arc shape.

48. The exposure apparatus according to claim 1 wherein
the liquid immersion member has a rotationally symmetric shape in an axis perpendicular to the first surface.

49. The exposure apparatus according to claim 1, the apparatus further comprising:
a liquid immersion member moving system which moves the liquid immersion member according a change of a gap with the object surface that accompanies a movement of the object.

50. The exposure apparatus according to claim 49 wherein
the liquid immersion member maintains a gap with a surface of the object to 10 to 200 μm.

51. The exposure apparatus according to claim 1, the apparatus further comprising;
a stage device which adjusts a relative positional relation between the object and a predetermined surface on which a pattern image is generated via the optical member during exposure; and
a liquid immersion member moving system which moves the liquid immersion member according to a position adjustment of the object by the stage device, so that a gap between the liquid immersion member and a surface of the object falls within a predetermined range.

52. The exposure apparatus according to claim 51 wherein
a gap between the liquid immersion member and a surface of the object is kept at 10 to 200 μm.

53. A device manufacturing method, including
exposing an object using the exposure apparatus according to claim 1; and
developing the object which has been exposed.

54. An exposure apparatus that exposes an object with an energy beam via an optical member and a liquid, the apparatus comprising:
a liquid immersion member which is placed facing the object to form a liquid immersion space of the liquid including a beam path of the energy beam between the optical member and the object, and has a first recess section to form an auxiliary liquid immersion space in between with the object formed on a first surface to which the object is placed opposing; and
a first liquid supply system which supplies the liquid to the liquid immersion space.

55. The exposure apparatus according to claim 54 wherein
the first recess section is formed on the first surface of the liquid immersion member in between an inner side surface and an outer side surface parallel to the object surface.

56. The exposure apparatus according to claim 54 wherein
in the inner bottom surface of the first recess section of the liquid immersion member, an inclined surface whose distance with the object surface becomes smaller from the inner side to the outer side is formed.

57. The exposure apparatus according to claim 56 wherein
the inclined surface has liquid repellency with a contact angle equal to or larger than 90 degrees.

58. The exposure apparatus according to claim 57 wherein
the inclined surface has liquid repellency with a contact angle equal to or larger than 130 degrees.

59. The exposure apparatus according to claim 57 wherein
the inclined surface has super liquid repellency with a contact angle equal to or larger than 150 degrees.

60. The exposure apparatus according to claim 56, the apparatus further comprising:
a second liquid supply system which supplies one of a same liquid as the liquid and a different liquid to the auxiliary liquid immersion space from the outside toward the inside.

61. The exposure apparatus according to claim 60 wherein
the second liquid supply system includes a liquid supply device which supplies liquid to the auxiliary liquid immersion space from the outer side toward the inner side via a supply opening provided on the inclined surface, and a liquid recovery device which recovers liquid inside the auxiliary liquid immersion space via a recovery opening located near the upper end of the inclined surface.

62. The exposure apparatus according to claim 61 wherein
in the first recess section of the liquid immersion member, a guide surface of liquid supplied to the auxiliary liquid immersion space is formed, facing the supply opening.

63. The exposure apparatus according to claim 62 wherein
the guide face includes a slope surface which faces a part of the inclined surface and rises upward to the inside from the first surface.

64. The exposure apparatus according to claim 61 wherein
recovery of liquid from the auxiliary liquid immersion space is performed in a state without the liquid being in contact with gas.

65. The exposure apparatus according to claim 61 wherein
supply of the liquid to the auxiliary liquid immersion space is performed in a state without the liquid being in contact with gas.

66. The exposure apparatus according to claim 61 wherein
temperature of liquid supplied to the liquid immersion space by the first liquid supply system and liquid supplied to the auxiliary liquid immersion space by the second liquid supply system is controlled separately.

67. The exposure apparatus according to claim 60 wherein
inside of the auxiliary liquid immersion space, a flow of the liquid is formed which suppresses the liquid that has flown in from leaking to the outside passing through a gap between the liquid immersion member and the object.

68. The exposure apparatus according to claim 56 wherein
in the liquid immersion member, a slit inclined to the first surface is formed on an edge on an outer side of the inclined surface.

69. The exposure apparatus according to claim 68 wherein
the slit is inclined downward from the outer side to the inner side, and the apparatus further comprises:
a purge gas supply system which supplies a purge gas with high humidity between the first recess section and the object via the slit.

70. The exposure apparatus according to claim 69 wherein
a recovery opening of the purge gas is formed at a position on the inner side of the slit on the inclined surface of the liquid immersion member.

71. The exposure apparatus according to claim 68, the apparatus further comprising:
a cleaning liquid supply system which supplies a cleaning liquid to the auxiliary liquid immersion space.

72. The exposure apparatus according to claim 71 wherein
the cleaning liquid is an alkaline solution.

73. The exposure apparatus according to claim 71 wherein
as the object, a wafer to which an HMDS treatment has been applied is used.

74. The exposure apparatus according to claim 54 wherein
the first liquid supply system supplies the liquid to the inside of a space formed in the center of the liquid immersion member.

75. The exposure apparatus according to claim 54 wherein
in the inner bottom surface of the first recess section of the liquid immersion member, grooves having a predetermined depth and a predetermined width are formed at a predetermined pitch.

76. The exposure apparatus according to claim 75 wherein
in the inner bottom surface of the first recess section of the liquid immersion member, an inclined surface whose distance with the object surface becomes smaller from the inner side to the outer side is formed.

77. The exposure apparatus according to claim 76 wherein
the inclined surface has liquid repellency with a contact angle equal to or larger than 90 degrees.

78. The exposure apparatus according to claim 75 wherein
the inner bottom section of the first recess section has liquid repellency with a contact angle equal to or larger than 110 degrees.

79. The exposure apparatus according to claim 75 wherein
the depth and the width of the grooves have a dimension around the same level as a gap between the first surface and the object surface.

80. The exposure apparatus according to claim 54 wherein
the first liquid supply system supplies a first liquid whose refractive index is one of equal to and less than a refractive index of an optical member located at the tip of the object side, into a space between the liquid immersion member, the optical member, and the object, and the apparatus further comprises:
a second liquid supply system which supplies a second liquid having a refractive index smaller than the first liquid and at the same level as water into the auxiliary liquid immersion space.

81. The exposure apparatus according to claim 80 wherein
the first liquid is a high refractive index liquid whose refractive index is equal to 1.50 or larger.

82. The exposure apparatus according to claim 81 wherein
the first liquid is a high refractive index liquid whose refractive index is around 1.60.

83. The exposure apparatus according to claim 80 wherein
in the inner bottom surface of the first recess section of the liquid immersion member, an inclined surface whose distance with the object surface becomes smaller from the inner side to the outer side is formed.

84. The exposure apparatus according to claim 83 wherein
the second liquid supply system supplies the second liquid from the outer side toward the inner side to the auxiliary liquid immersion space.

85. The exposure apparatus according to claim 83 wherein
the inclined surface has liquid repellency with a contact angle equal to or larger than 130 degrees.

86. The exposure apparatus according to claim 85 wherein
the inclined surface has super liquid repellency with a contact angle equal to and larger than 150 degrees.

87. The exposure apparatus according to claim 80 wherein
the second liquid supply system includes a liquid supply device which supplies liquid to the auxiliary liquid immersion space from the outer side toward the inner side via a supply opening provided on the inclined surface, and a liquid recovery device which recovers liquid inside the auxiliary liquid immersion space via a recovery opening located near the upper end of the inclined surface.

88. The exposure apparatus according to claim 87 wherein
in the first recess section of the liquid immersion member, a guide surface of liquid supplied to the auxiliary liquid immersion space is formed, facing the supply opening.

89. The exposure apparatus according to claim 88 wherein
the guide surface includes a slope surface which faces apart of the inclined surface and rises upward to the inside from the first surface.

90. The exposure apparatus according to claim 87 wherein
recovery of liquid from the auxiliary liquid immersion space and liquid supply to the auxiliary liquid immersion space by the second liquid supply system are performed in a state without the liquid being in contact with gas.

91. The exposure apparatus according to claim 90 wherein
temperature of the first liquid supplied to the liquid immersion space by the first liquid supply system and the second liquid supplied to the auxiliary liquid immersion space by the second liquid supply system is controlled separately.

92. The exposure apparatus according to claim 54 wherein
on the first surface of the liquid immersion member, on the inner side of the first recess section formed on the first surface, a second recess section to form a buffer space between the liquid immersion member and the object is formed.

93. The exposure apparatus according to claim 92 wherein
on a side facing the beam path of the liquid immersion member, an inner side projecting section which faces a part of a periphery of an outgoing surface of the optical member is provided.

94. The exposure apparatus according to claim 93 wherein
between the inner side projecting section and an inner side wall section of the second recess section, a recovery path of liquid is formed.

95. The exposure apparatus according to claim 94 wherein
in the second recess section of the liquid immersion member, a recovery opening to collect liquid from within a buffer space formed between the second recess section and the object is formed.

96. The exposure apparatus according to claim 95 wherein
the recovery opening is connected to a recovery section communicating with the recovery path.

97. The exposure apparatus according to claim 54 wherein
on a side facing the beam path of the liquid immersion member, an inner side projecting section which faces a part of a periphery of an outgoing surface of the optical member is provided.

98. The exposure apparatus according to claim 97 wherein
a distance of the inner side projecting section with the object surface is larger than a distance of the first surface with the object.

99. The exposure apparatus according to claim 97 wherein
a surface on the side of the inner side projecting section facing the object has a shape whose distance with the object surface from the inner side to the outer side gradually becomes large, after gradually becoming small.

100. The exposure apparatus according to claim 99 wherein
the surface of inner side projecting section is a surface whose cross section is an arc shape.

101. The exposure apparatus according to claim 54 wherein
the liquid immersion member has a rotationally symmetric shape in an axis perpendicular to the first surface.

102. The exposure apparatus according to claim 54, the apparatus further comprising:
a liquid immersion member moving system which moves the liquid immersion member according a change of a gap with the object surface that accompanies a movement of the object.

103. The exposure apparatus according to claim 102 wherein
a gap between the liquid immersion member and a surface of the object is kept at 10 to 200 μm.

104. The exposure apparatus according to claim 54, the apparatus further comprising:
a stage device which adjusts a relative positional relation between the object and a predetermined surface on which a pattern image is generated via the optical member during exposure: and
a liquid immersion member moving system which moves the liquid immersion member according to a position adjustment of the object by the stage device, so that a gap between the liquid immersion member and a surface of the object falls within a predetermined range.

105. The exposure apparatus according to claim 104 wherein
a gap between the liquid immersion member and a surface of the object is kept at 10 to 200 μm.

106. A device manufacturing method, including
exposing an object using the exposure apparatus according to claim 54; and
developing the object which has been exposed.

107. A liquid immersion member which fills liquid in a space between an optical member and an object and forms a liquid immersion space, and is attached to an exposure apparatus which exposes the object with an energy beam via the optical member and the liquid, the member comprising:
a main section which can be placed facing the object on an outer side of a beam path of the energy beam, and also has a space formed in the center to form the liquid immersion space, wherein
a first recess section to form an auxiliary liquid immersion space between the object is formed on a first surface of the main section facing the object.

108. The liquid immersion member according to claim 107 wherein
the first recess section is formed of double projecting sections formed on the inner side and the outer side of the first surface of the main section.

109. The liquid immersion member according to claim 107 wherein
in the inner bottom surface of the first recess section, a liquid repellent inclined surface whose distance with the object surface becomes smaller from the inner side to the outer side is formed.

110. The liquid immersion member according to claim. 109 wherein
the inclined surface has liquid repellency with a contact angle equal to or larger than 130 degrees.

111. The liquid immersion member according to claim 110 wherein
the inclined surface has super liquid repellency with a contact angle equal to or larger than 150 degrees.

112. The liquid immersion member according to claim 109 wherein
a slit inclined to the first surface is provided on an edge on an outer side of the inclined surface of the main section.

113. The liquid immersion member according to claim 112 wherein
the slit serves as a supply path of a purge gas with high humidity which tilts downward toward the inside from the outside.

114. The liquid immersion member according to claim 113 wherein
a recovery opening of the purge gas is formed at the foot of the inclined surface of the main section.

115. The liquid immersion member according to claim 107 wherein
in the inner bottom surface of the first recess section, grooves having a predetermined depth and a predetermined width are formed at a predetermined pitch.

116. The liquid immersion member according to claim 115 wherein
the depth and the width of the grooves have a dimension around the same level as a gap between the first surface and the object surface.

117. The liquid immersion member according to claim 115 wherein
in the inner bottom surface of the first recess section, a supply opening of liquid supplied to the auxiliary liquid immersion space is formed.

118. The liquid immersion member according to claim 115 wherein
in the inner bottom surface of the first recess section, a plurality of the supply openings is formed corresponding to the plurality of grooves, respectively.

119. The liquid immersion member according to claim 117 wherein
in the inner bottom surface of the first recess section, a liquid repellent inclined surface whose distance with the object surface becomes smaller from the inner side to the outer side is formed.

120. The liquid immersion member according to claim 119 wherein
the supply opening is formed in the inclined surface so that liquid is supplied from the outer side toward the inner side via the supply opening.

121. The liquid immersion member according to claim 120 wherein
in the first recess section of the main section, a guide surface of liquid supplied to the auxiliary liquid immersion space is formed, facing the supply opening.

122. The liquid immersion member according to claim 121 wherein
the guide face includes a slope surface which faces a part of the inclined surface and rises upward to the inside from the first surface.

123. The liquid immersion member according to claim 120 wherein
in the first recess section, a recovery opening of liquid recovered from the auxiliary liquid immersion space is provided.

124. The liquid immersion member according to claim 115 wherein
the inner bottom section of the first recess section has liquid repellency with a contact angle equal to or larger than 110 degrees.

125. The liquid immersion member according to claim 109 wherein
in the inclined surface of the main section, a supply opening of liquid supplied toward the inside from the outside is formed.

126. The liquid immersion member according to claim 125 wherein
in the first recess section of the main section, a guide surface of liquid supplied to the auxiliary liquid immersion space is formed, facing the supply opening.

127. The liquid immersion member according to claim 126 wherein
the guide surface includes a slope surface which faces a part of the inclined surface and rises upward to the inside from the first surface.

128. The liquid immersion member according to claim 125 wherein
in the first recess section, a recovery opening of liquid recovered from the auxiliary liquid immersion space is provided.

129. The liquid immersion member according to claim 107 wherein
on a side facing the beam path of the main section, an inner side projecting section which faces a part of a periphery of an outgoing surface of the optical member is provided.

130. The liquid immersion member according to claim 129 wherein
a distance of the inner side projecting section with the object surface is larger than a distance of the first surface with the object.

131. The liquid immersion member according to claim 129 wherein
a surface on the side of the inner side projecting section facing the object has a shape whose distance with the object surface from the inner side to the outer side gradually becomes large, after gradually becoming small.

132. The liquid immersion member according to claim 131 wherein
the surface of inner side projecting section is a surface whose cross section is an arc shape.

133. The liquid immersion member according to claim 129 wherein
on a surface of the inner side projection section of the main section on a side facing the object, an upper guide surface of a slope shape which gradually rises upward toward the outside is formed, and in a part of the main section facing the upper guide surface, a lower guide surface of a slope shape which rises upward toward the outside is formed, and in between the upper guide surface and the lower guide surface, a recovery path of liquid is formed.

134. The liquid immersion member according to claim 107 wherein
on the first surface of the main section, on the inner side of the first recess section formed on the first surface, a second recess section to form a buffer space between the liquid immersion member and the object is formed.

135. The liquid immersion member according to claim 134 wherein
in the second recess section of the main section, a recovery opening of liquid inside of the buffer space is formed.

136. The liquid immersion member according to claim 135 wherein
the recovery opening is connected to a recovery section communicating with the recovery path.

137. The liquid immersion member according to claim 107 wherein
the main section has a rotationally symmetric shape in an axis perpendicular to the first surface.
